(19) United States
(12) Patent Application Publication
(10) Pub. No.: US 2026/0254685 A1
(43) Pub. Date: Aug. 27, 2026

(54) DESIGNS OF DATA AND PILOT SUBCARRIER INDICES OF WIDE BANDWIDTH RESOURCE UNIT FOR NEXT-GENERATION WLAN

(71) Applicant: MEDIATEK INC., Hsinchu City (TW)

(72) Inventors: Shengquan HU, San Jose, CA (US); Jianhan LIU, San Jose, CA (US); Thomas Edward PARE, JR., San Jose, CA (US)

(21) Appl. No.: 18/870,697

(22) PCT Filed: Jun. 9, 2023
(86) PCT No.: PCT/CN2023/099508

§ 371 Date: Dec. 2, 2024

Related U.S. Application Data
(60) Provisional application No. 63/350,923, filed on Jun. 10, 2022.

(51) Int. Cl. H04L 27/26; H04L 5/00

(52) U.S. Cl. CPC H04L 27/26025; H04L 5/0048

(57) ABSTRACT

Techniques pertaining to designs of data and pilot subcarrier indices of wide bandwidth resource unit (RU) for next-generation wireless local area networks (WLANs) are described. An apparatus (e.g., station (STA)) generates one or more RUs with a subcarrier spacing (SCS) of 78.125 kHz and with a constant shift applied to at least a portion of data and pilot subcarrier indices of the one or more RUs. The apparatus then wirelessly transmits the one or more RUs in a wide bandwidth greater than 80 MHz.

### CROSS REFERENCE TO RELATED PATENT APPLICATION

The present disclosure is part of a non-provisional patent application claiming the priority benefit of U.S. Provisional Patent Application Nos. 63/350,923, filed 10 Jun. 2022, the content of which herein being incorporated by reference in its entirety.

### TECHNICAL FIELD

The present disclosure is generally related to wireless communications and, more particularly, to designs of data and pilot subcarrier indices of wide bandwidth resource unit (RU) for next-generation wireless local area networks (WLANs).

### BACKGROUND

Unless otherwise indicated herein, approaches described in this section are not prior art to the claims listed below and are not admitted as prior art by inclusion in this section.

In wireless communications such as Wi-Fi (or WiFi) in accordance with the Institute of Electrical and Electronics Engineers (IEEE) 802.11 standards, wider bandwidth tends to be an efficient way to achieve higher throughputs for next-generation WLANs. However, at the present time, designs of data and pilot subcarrier indices of RUs for transmission of physical-layer protocol data units (PPDUs) in wider bandwidths, such as 240 MHz, 480 MHz, 560 MHz and 640 MHz, have yet to be defined. Therefore, there is a need for a solution of designs of data and pilot subcarrier indices of wide bandwidth RUs for next-generation WLANs.

### SUMMARY

The following summary is illustrative only and is not intended to be limiting in any way. That is, the following summary is provided to introduce concepts, highlights, benefits and advantages of the novel and non-obvious techniques described herein. Select implementations are further described below in the detailed description. Thus, the following summary is not intended to identify essential features of the claimed subject matter, nor is it intended for use in determining the scope of the claimed subject matter.

An objective of the present disclosure is to provide schemes, concepts, designs, techniques, methods and apparatuses pertaining to designs of data and pilot subcarrier indices of wide bandwidth RUs for next-generation WLANs.

In one aspect, a method may involve generating one or more RUs with a subcarrier spacing (SCS) of 78.125 kHz and with a constant shift applied to at least a portion of data and pilot subcarrier indices of the one or more RUs. The method may also involve wirelessly transmitting the one or more RUs in a wide bandwidth greater than 80 MHz.

In another aspect, an apparatus may include a transceiver configured to communicate wirelessly and a processor coupled to the transceiver. The processor may generate one or more RUs with a SCS of 78.125 kHz and with a constant shift applied to at least a portion of data and pilot subcarrier indices of the one or more RUs. The processor may also wirelessly transmit the one or more RUs in a wide bandwidth greater than 80 MHz.

It is noteworthy that, although description provided herein may be in the context of certain radio access technologies, networks and network topologies such as, Wi-Fi, the proposed concepts, schemes and any variation(s)/derivative(s) thereof may be implemented in, for and by other types of radio access technologies, networks and network topologies such as, for example and without limitation, Bluetooth, ZigBee, 5^{th} Generation (5G)/New Radio (NR), Long-Term Evolution (LTE), LTE-Advanced, LTE-Advanced Pro, Internet-of-Things (IoT), Industrial IoT (IIoT) and narrowband IoT (NB-IoT). Thus, the scope of the present disclosure is not limited to the examples described herein.

### BRIEF DESCRIPTION OF THE DRAWINGS

The accompanying drawings are included to provide a further understanding of the disclosure and are incorporated in and constitute a part of the present disclosure. The drawings illustrate implementations of the disclosure and, together with the description, serve to explain the principles of the disclosure. It is appreciable that the drawings are not necessarily in scale as some components may be shown to be out of proportion than the size in actual implementation to clearly illustrate the concept of the present disclosure.

FIG. 1 is a diagram of an example network environment in which various solutions and schemes in accordance with the present disclosure may be implemented.

FIG. 2 is a diagram of an example design under a proposed scheme in accordance with the present disclosure.

FIG. 3 is a diagram of an example design under a proposed scheme in accordance with the present disclosure.

FIG. 4 is a diagram of an example design under a proposed scheme in accordance with the present disclosure.

FIG. 5 is a diagram of an example design under a proposed scheme in accordance with the present disclosure.

FIG. 6 is a diagram of an example design under a proposed scheme in accordance with the present disclosure.

FIG. 7 is a diagram of an example design under a proposed scheme in accordance with the present disclosure.

FIG. 8 is a diagram of an example design under a proposed scheme in accordance with the present disclosure.

FIG. 9 is a diagram of an example design under a proposed scheme in accordance with the present disclosure.

FIG. 10 is a diagram of an example design under a proposed scheme in accordance with the present disclosure.

FIG. 11 is a diagram of an example design under a proposed scheme in accordance with the present disclosure.

FIG. 12 is a diagram of an example design under a proposed scheme in accordance with the present disclosure.

FIG. 13 is a diagram of an example design under a proposed scheme in accordance with the present disclosure.

FIG. 14 is a diagram of an example design under a proposed scheme in accordance with the present disclosure.

FIG. 15 is a diagram of an example design under a proposed scheme in accordance with the present disclosure.

FIG. 16A~FIG. 16C each shows a portion of an example design under a proposed scheme in accordance with the present disclosure.

FIG. 17A~FIG. 17F each shows a portion of an example design under a proposed scheme in accordance with the present disclosure.

FIG. 18A~FIG. 18F each shows a portion of an example design under a proposed scheme in accordance with the present disclosure.

FIG. 19 is a block diagram of an example communication system in accordance with an implementation of the present disclosure.

FIG. 20 is a flowchart of an example process in accordance with an implementation of the present disclosure.

### DETAILED DESCRIPTION OF PREFERRED EMBODIMENTS

Detailed embodiments and implementations of the claimed subject matters are disclosed herein. However, it shall be understood that the disclosed embodiments and implementations are merely illustrative of the claimed subject matters which may be embodied in various forms. The present disclosure may, however, be embodied in many different forms and should not be construed as limited to the exemplary embodiments and implementations set forth herein. Rather, these exemplary embodiments and implementations are provided so that description of the present disclosure is thorough and complete and will fully convey the scope of the present disclosure to those skilled in the art. In the description below, details of well-known features and techniques may be omitted to avoid unnecessarily obscuring the presented embodiments and implementations.

### Overview

Implementations in accordance with the present disclosure relate to various techniques, methods, schemes and/or solutions pertaining to designs of data and pilot subcarrier indices of wide bandwidth RUs for next-generation WLANs. According to the present disclosure, a number of possible solutions may be implemented separately or jointly. That is, although these possible solutions may be described below separately, two or more of these possible solutions may be implemented in one combination or another.

It is noteworthy that, in the present disclosure, a regular RU (rRU) refers to a RU with tones that are continuous (e.g., adjacent to one another) and not interleaved, interlaced or otherwise distributed. Moreover, a 26-tone regular RU may be interchangeably denoted as RU26 (or rRU26), a 52-tone regular RU may be interchangeably denoted as RU52 (or rRU52), a 106-tone regular RU may be interchangeably denoted as RU106 (or rRU106), a 242-tone regular RU may be interchangeably denoted as RU242 (or rRU242), and so on. Moreover, an aggregate (26+52)-tone regular multi-RU (MRU) may be interchangeably denoted as MRU(26+52) or MRU(52+26) or MRU78 (or rMRU78), an aggregate (26+106)-tone regular MRU may be interchangeably denoted as MRU(26+106) or MRU(106+26) or MRU132 (or rMRU132), and so on.

It is also noteworthy that, in the present disclosure, a bandwidth of 20 MHz may be interchangeably denoted as BW20 or BW20M, a bandwidth of 40 MHz may be interchangeably denoted as BW40 or BW40M, a bandwidth of 80 MHz may be interchangeably denoted as BW80 or BW80M, a bandwidth of 160 MHz may be interchangeably denoted as BW160 or BW160M, a bandwidth of 240 MHz may be interchangeably denoted as BW240 or BW240M, a bandwidth of 320 MHz may be interchangeably denoted as BW320 or BW320M, a bandwidth of 480 MHz may be interchangeably denoted as BW480 or BW480M, a bandwidth of 640 MHz may be interchangeably denoted as BW640 or BW640M

It is further noteworthy that, in the present disclosure, the term “small-size MRU” refers to an aggregate of multiple RUs of 106 tones or fewer, such as 26 tones, 52 tones and/or 106 tones. Moreover, the term “large-size MRU” refers to an aggregate of multiple RUs of 242 tones or more, such as 242 tones, 484 tones and/or 996 tones.

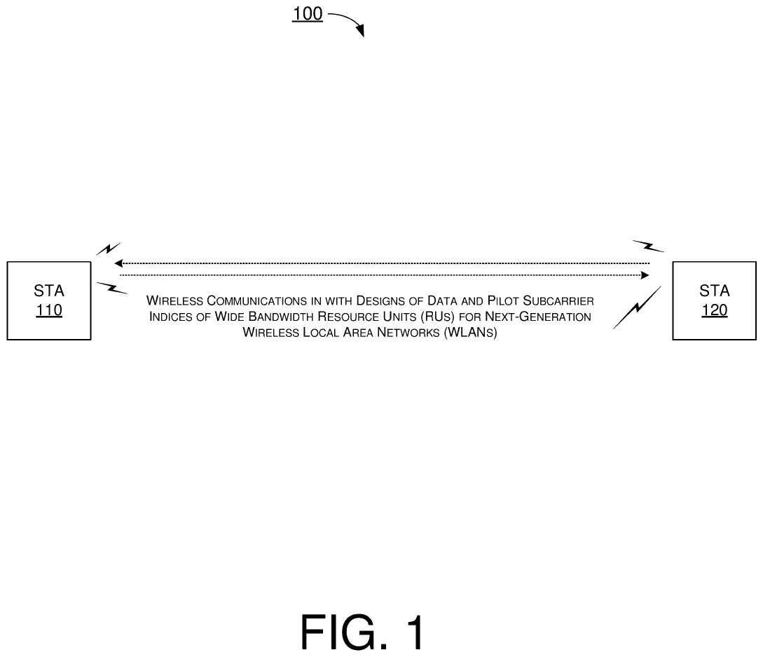

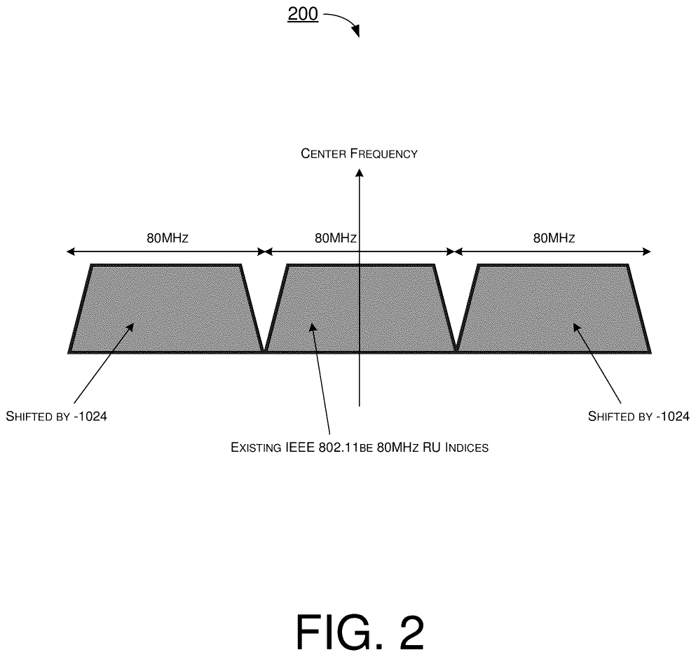

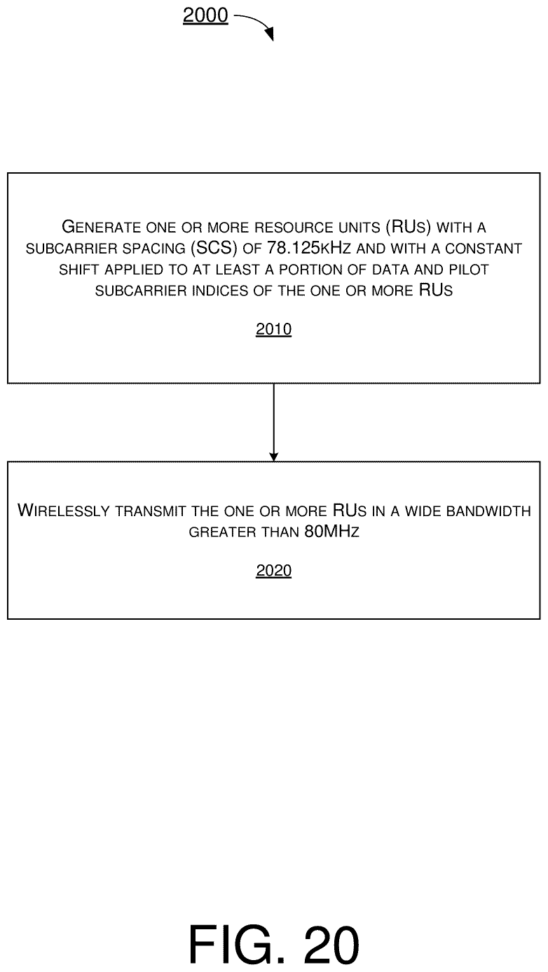

FIG. 1 illustrates an example network environment 100 in which various solutions and schemes in accordance with the present disclosure may be implemented. FIG. 2~FIG. 20 illustrate examples of implementation of various proposed schemes in network environment 100 in accordance with the present disclosure. The following description of various proposed schemes is provided with reference to FIG. 1~FIG. 20.

Referring to FIG. 1, network environment 100 may involve at least a station (STA) 110 communicating wirelessly with a STA 120. Either of STA 110 and STA 120 may be a non-access point (non-AP) STA or, alternatively, either of STA 110 and STA 120 may function as an access point (AP) STA. In some cases, STA 110 and STA 120 may be associated with a basic service set (BSS) in accordance with one or more IEEE 802.11 standards (e.g., IEEE 802.11be and future-developed standards). Each of STA 110 and STA 120 may be configured to communicate with each other by utilizing the designs of data and pilot subcarrier indices of wide bandwidth RUs for next-generation WLANs in accordance with various proposed schemes described below. That is, either or both of STA 110 and STA 120 may function as a “user” in the proposed schemes and examples described below. It is noteworthy that, while the various proposed schemes may be individually or separately described below, in actual implementations some or all of the proposed schemes may be utilized or otherwise implemented jointly. Of course, each of the proposed schemes may be utilized or otherwise implemented individually or separately.

Under various proposed schemes in accordance with the present disclosure, designs of data and pilot subcarrier indices (or data and pilot tones) of RUs of different sizes for transmission in a wide bandwidth, such as 240 MHz, 480 MHz and 640 MHz, may be based on a subcarrier spacing (SCS) of 78.125 kHz. Such designs may be beneficial for backward compatibility as SCS=78.125 kHz has been defined in the IEEE 802.11be specification.

FIG. 2 illustrates an example design 200 under a proposed scheme in accordance with the present disclosure. Design 200 pertains to data and pilot subcarrier indices for RUs in the 240 MHz bandwidth (BW240). Referring to FIG. 2, in design 200, both data and pilot subcarrier indices may be generated based on existing 80 MHz RU subcarrier indices, as defined in the IEEE 802.11be specification, by a constant shift with respect to a center frequency. Under the proposed scheme, with a plurality of data and pilot subcarrier indices of 80 MHz RU(s) symmetrically distributed around a center frequency, data and pilot subcarrier indices for 80 MHz RU(s) to either side of the center frequency may be generated with a constant shift. For instance, data and pilot subcarrier indices for 80 MHz RU(s) to the left side of the center frequency may be generated with a shift of −1024, and data and pilot subcarrier indices for 80 MHz RU(s) to the right side of the center frequency may be generated with a shift of +1024.

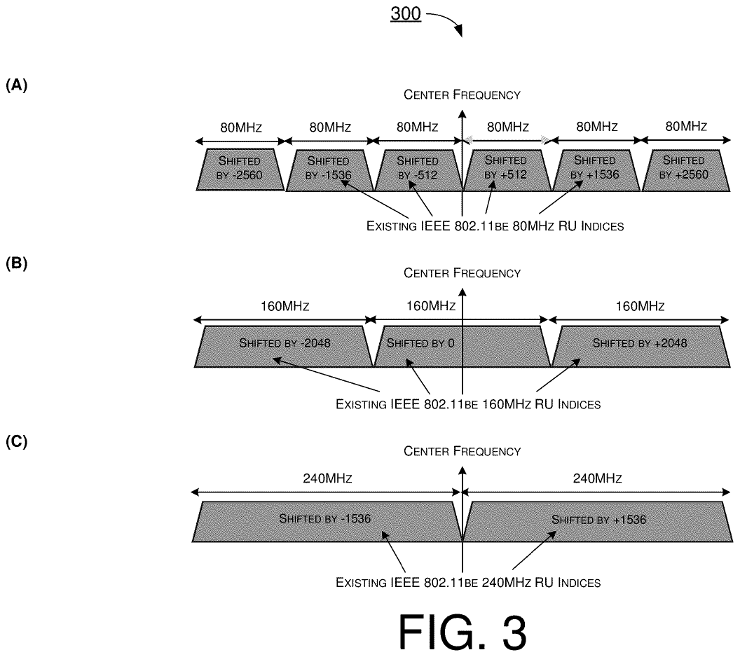

FIG. 3 illustrates an example design 300 under a proposed scheme in accordance with the present disclosure. Design 300 pertains to data and pilot subcarrier indices for RUs in the 480 MHz bandwidth (BW480). Under the proposed scheme, there may be different options (Option-1, Option-2 and Option-3). In Option-1 as shown in part (A) of FIG. 3, data and pilot subcarrier indices of RUs in BW480 may be generated by a constant shift (with respect to a center frequency) from existing 80 MHz RU subcarrier indices as defined in the IEEE 802.11be specification. In Option-2 as shown in part (B) of FIG. 3, data and pilot subcarrier indices of RUs in BW480 may be generated by a constant shift from existing 160 MHz RU subcarrier indices as defined in the IEEE 802.11be specification. In Option-3 as shown in part (C) of FIG. 3, data and pilot subcarrier indices of RUs in BW480 may be generated by a constant shift from existing 240 MHz RU subcarrier indices as defined in the IEEE 802.11be specification.

In Option-1, data and pilot subcarrier indices for 80 MHz RU(s) to either side of the center frequency may be generated with a constant shift. For instance, data and pilot subcarrier indices for 80 MHz RU(s) to the left side of the center frequency may be generated with a shift of −2560, −1536 or −512, and data and pilot subcarrier indices for 80 MHz RU(s) to the right side of the center frequency may be generated with a shift of +512, +1536 or +2560.

In Option-2, with a plurality of data and pilot subcarrier indices of 160 MHz RU(s) symmetrically distributed around a center frequency (e.g., shifted by 0), data and pilot subcarrier indices for 160 MHz RU(s) to either side of the center frequency may be generated with a constant shift. For instance, data and pilot subcarrier indices for 160 MHz RU(s) to the left side of the center frequency may be generated with a shift of −2048, and data and pilot subcarrier indices for 160 MHz RU(s) to the right side of the center frequency may be generated with a shift of +2048.

In Option-3, data and pilot subcarrier indices for 240 MHz RU(s) to either side of the center frequency may be generated with a constant shift. For instance, data and pilot subcarrier indices for 240 MHz RU(s) to the left side of the center frequency may be generated with a shift of −1536, and data and pilot subcarrier indices for 240 MHz RU(s) to the right side of the center frequency may be generated with a shift of +1536.

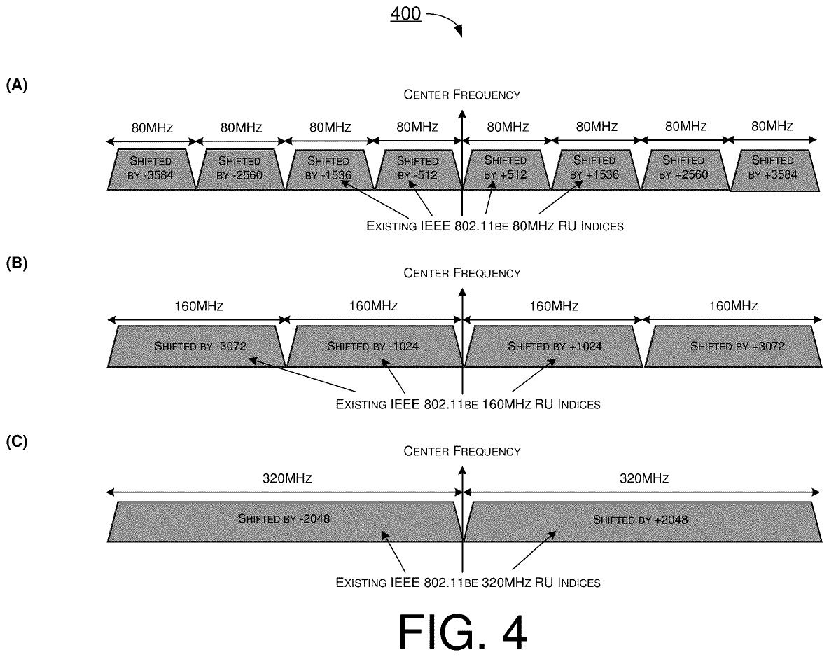

FIG. 4 illustrates an example design 400 under a proposed scheme in accordance with the present disclosure. Design 400 pertains to data and pilot subcarrier indices for RUs in the 640 MHz bandwidth (BW640). Under the proposed scheme, there may be different options (Option-1, Option-2 and Option-3). In Option-1 as shown in part (A) of FIG. 4, data and pilot subcarrier indices of RUs in BW640 may be generated by a constant shift from existing 80 MHz RU subcarrier indices as defined in the IEEE 802.11be specification. In Option-2 as shown in part (B) of FIG. 4, data and pilot subcarrier indices of RUs in BW640 may be generated by a constant shift from existing 160 MHz RU subcarrier indices as defined in the IEEE 802.11be specification. In Option-3 as shown in part (C) of FIG. 4, data and pilot subcarrier indices of RUs in BW640 may be generated by a constant shift from existing 320 MHz RU subcarrier indices as defined in the IEEE 802.11be specification.

In Option-1, data and pilot subcarrier indices for 80 MHz RU(s) to either side of the center frequency may be generated with a constant shift. For instance, data and pilot subcarrier indices for 80 MHz RU(s) to the left side of the center frequency may be generated with a shift of −3584, −2560, −1536 or −512, and data and pilot subcarrier indices for 80 MHz RU(s) to the right side of the center frequency may be generated with a shift of +512, +1536, +2560 or +3584.

In Option-2, data and pilot subcarrier indices for 160 MHz RU(s) to either side of the center frequency may be generated with a constant shift. For instance, data and pilot subcarrier indices for 160 MHz RU(s) to the left side of the center frequency may be generated with a shift of −3072 or −1024, and data and pilot subcarrier indices for 160 MHz RU(s) to the right side of the center frequency may be generated with a shift of +1024 or +3072.

In Option-3, data and pilot subcarrier indices for 320 MHz RU(s) to either side of the center frequency may be generated with a constant shift. For instance, data and pilot subcarrier indices for 320 MHz RU(s) to the left side of the center frequency may be generated with a shift of −2048, and data and pilot subcarrier indices for 320 MHz RU(s) to the right side of the center frequency may be generated with a shift of +2048.

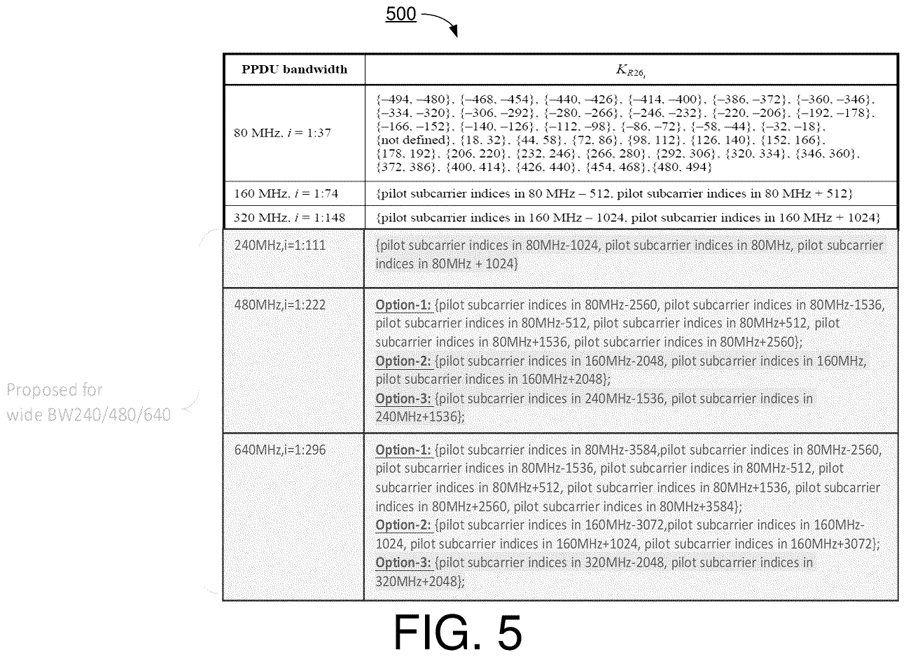

FIG. 5 illustrates an example design 500 under a proposed scheme in accordance with the present disclosure. Under the proposed scheme, pilot indices for transmission of a 26-tone RU in a wide bandwidth, such as BW240, BW480 and/or BW640, may be provided. Under the proposed scheme, the index i of pilot subcarrier indices for transmissions of 26-tone RUs in BW240 may be in a range of 1~111 (e.g., i=1:111) for the pilot subcarrier indices in the 80 MHz RU(s) with a constant shift of −1024, for the pilot subcarrier indices in the 80 MHz RU(s) centered around the center frequency, and the pilot subcarrier indices in the 80 MHz RU(s) with a constant shift of +1024.

Under the proposed scheme, the index i of pilot subcarrier indices for transmissions of 26-tone RUs in BW480 may be in a range of 1~222 (e.g., i=1:222) under the different options. In Option-1, i=1:222 for the pilot subcarrier indices in the 80 MHz RU(s) with a constant shift of −2560, for the pilot subcarrier indices in the 80 MHz RU(s) with a constant shift of −1536, for the pilot subcarrier indices in the 80 MHz RU(s) with a constant shift of −512, for the pilot subcarrier indices in the 80 MHz RU(s) with a constant shift of +512, for the pilot subcarrier indices in the 80 MHz RU(s) with a constant shift of +1536, and the pilot subcarrier indices in the 80 MHz RU(s) with a constant shift of +2560. In Option-2, i=1:222 for the pilot subcarrier indices in the 160 MHz RU(s) with a constant shift of −2048, for the pilot subcarrier indices in the 160 MHz RU(s) centered around the center frequency, and the pilot subcarrier indices in the 160 MHz RU(s) with a constant shift of +2048. In Option-3, i=1:222 for the pilot subcarrier indices in the 240 MHz RU(s) with a constant shift of −1536 and the pilot subcarrier indices in the 240 MHz RU(s) with a constant shift of +1536.

Under the proposed scheme, the index i of pilot subcarrier indices for transmissions of 26-tone RUs in BW640 may be in a range of 1~296 (e.g., i=1:296) under the different options. In Option-1, i=1:296 for the pilot subcarrier indices in the 80 MHz RU(s) with a constant shift of −3584, for the pilot subcarrier indices in the 80 MHz RU(s) with a constant shift of −2560, for the pilot subcarrier indices in the 80 MHz RU(s) with a constant shift of −1536, for the pilot subcarrier indices in the 80 MHz RU(s) with a constant shift of −512, for the pilot subcarrier indices in the 80 MHz RU(s) with a constant shift of +512, for the pilot subcarrier indices in the 80 MHz RU(s) with a constant shift of +1536, the pilot subcarrier indices in the 80 MHz RU(s) with a constant shift of +2560, and the pilot subcarrier indices in the 80 MHz RU(s) with a constant shift of +3584. In Option-2, i=1:296 for the pilot subcarrier indices in the 160 MHz RU(s) with a constant shift of −3072, for the pilot subcarrier indices in the 160 MHz RU(s) with a constant shift of −1024, for the pilot subcarrier indices in the 160 MHz RU(s) with a constant shift of +1024, and the pilot subcarrier indices in the 160 MHz RU(s) with a constant shift of +3072. In Option-3, i=1:296 for the pilot subcarrier indices in the 320 MHz RU(s) with a constant shift of −2048 and the pilot subcarrier indices in the 320 MHz RU(s) with a constant shift of +2048.

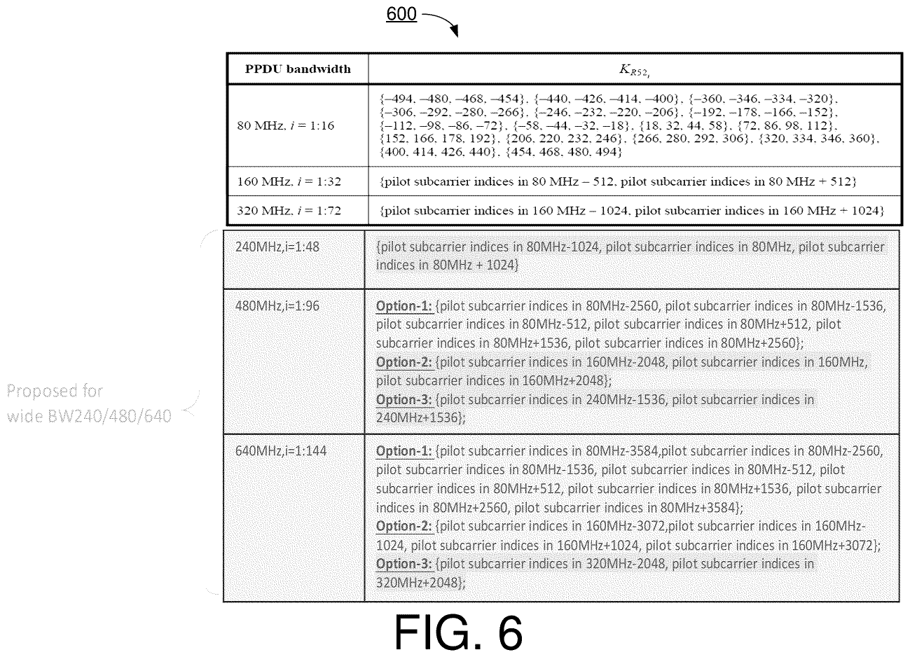

FIG. 6 illustrates an example design 600 under a proposed scheme in accordance with the present disclosure. Under the proposed scheme, pilot indices for transmission of a 52-tone RU in a wide bandwidth, such as BW240, BW480 and/or BW640, may be provided. Under the proposed scheme, the index i of pilot subcarrier indices for transmissions of 52-tone RUs in BW240 may be in a range of 1~48 (e.g., i=1:48) for the pilot subcarrier indices in the 80 MHz RU(s) with a constant shift of −1024, for the pilot subcarrier indices in the 80 MHz RU(s) centered around the center frequency, and the pilot subcarrier indices in the 80 MHz RU(s) with a constant shift of +1024.

Under the proposed scheme, the index i of pilot subcarrier indices for transmissions of 52-tone RUs in BW480 may be in a range of 1~96 (e.g., i=1:96) under the different options. In Option-1, i=1:96 for the pilot subcarrier indices in the 80 MHz RU(s) with a constant shift of −2560, for the pilot subcarrier indices in the 80 MHz RU(s) with a constant shift of −1536, for the pilot subcarrier indices in the 80 MHz RU(s) with a constant shift of −512, for the pilot subcarrier indices in the 80 MHz RU(s) with a constant shift of +512, for the pilot subcarrier indices in the 80 MHz RU(s) with a constant shift of +1536, and the pilot subcarrier indices in the 80 MHz RU(s) with a constant shift of +2560. In Option-2, i=1:96 for the pilot subcarrier indices in the 160 MHz RU(s) with a constant shift of −2048 and the pilot subcarrier indices in the 160 MHz RU(s) with a constant shift of +2048. In Option-3, i=1:96 for the pilot subcarrier indices in the 240 MHz RU(s) with a constant shift of −1536 and the pilot subcarrier indices in the 240 MHz RU(s) with a constant shift of +1536.

Under the proposed scheme, the index i of pilot subcarrier indices for transmissions of 52-tone RUs in BW640 may be in a range of 1~144 (e.g., i=1:144) under the different options. In Option-1, i=1:144 for the pilot subcarrier indices in the 80 MHz RU(s) with a constant shift of −3584, for the pilot subcarrier indices in the 80 MHz RU(s) with a constant shift of −2560, for the pilot subcarrier indices in the 80 MHz RU(s) with a constant shift of −1536, for the pilot subcarrier indices in the 80 MHz RU(s) with a constant shift of −512, for the pilot subcarrier indices in the 80 MHz RU(s) with a constant shift of +512, for the pilot subcarrier indices in the 80 MHz RU(s) with a constant shift of +1536, the pilot subcarrier indices in the 80 MHz RU(s) with a constant shift of +2560, and the pilot subcarrier indices in the 80 MHz RU(s) with a constant shift of +3584. In Option-2, i=1:144 for the pilot subcarrier indices in the 160 MHz RU(s) with a constant shift of −3072, for the pilot subcarrier indices in the 160 MHz RU(s) with a constant shift of −1024, for the pilot subcarrier indices in the 160 MHz RU(s) with a constant shift of +1024, and the pilot subcarrier indices in the 160 MHz RU(s) with a constant shift of +3072. In Option-3, i=1:144 for the pilot subcarrier indices in the 320 MHz RU(s) with a constant shift of −2048 and the pilot subcarrier indices in the 320 MHz RU(s) with a constant shift of +2048.

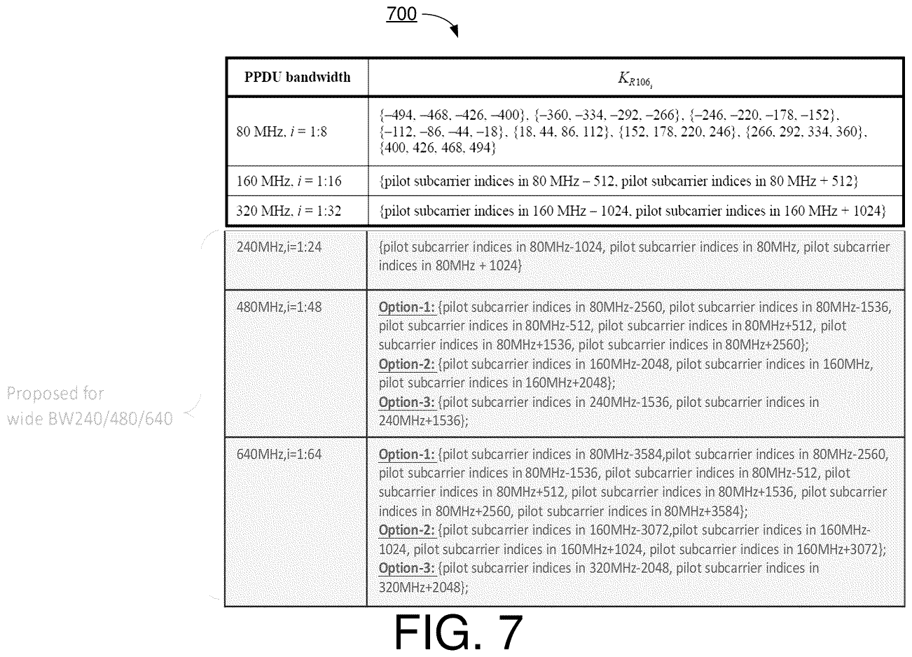

FIG. 7 illustrates an example design 700 under a proposed scheme in accordance with the present disclosure. Under the proposed scheme, pilot indices for transmission of a 106-tone RU in a wide bandwidth, such as BW240, BW480 and/or BW640, may be provided. Under the proposed scheme, the index i of pilot subcarrier indices for transmissions of 106-tone RUs in BW240 may be in a range of 1~24 (e.g., i=1:24) for the pilot subcarrier indices in the 80 MHz RU(s) with a constant shift of −1024 and the pilot subcarrier indices in the 80 MHz RU(s) with a constant shift of +1024.

Under the proposed scheme, the index i of pilot subcarrier indices for transmissions of 106-tone RUs in BW480 may be in a range of 1~48 (e.g., i=1:48) under the different options. In Option-1, i=1:48 for the pilot subcarrier indices in the 80 MHz RU(s) with a constant shift of −2560, for the pilot subcarrier indices in the 80 MHz RU(s) with a constant shift of −1536, for the pilot subcarrier indices in the 80 MHz RU(s) with a constant shift of −512, for the pilot subcarrier indices in the 80 MHz RU(s) with a constant shift of +512, for the pilot subcarrier indices in the 80 MHz RU(s) with a constant shift of +1536, and the pilot subcarrier indices in the 80 MHz RU(s) with a constant shift of +2560. In Option-2, i=1:48 for the pilot subcarrier indices in the 160 MHz RU(s) with a constant shift of −2048 and the pilot subcarrier indices in the 160 MHz RU(s) with a constant shift of +2048. In Option-3, i=1:48 for the pilot subcarrier indices in the 240 MHz RU(s) with a constant shift of −1536 and the pilot subcarrier indices in the 240 MHz RU(s) with a constant shift of +1536.

Under the proposed scheme, the index i of pilot subcarrier indices for transmissions of 106-tone RUs in BW640 may be in a range of 1~64 (e.g., i=1:64) under the different options. In Option-1, i=1:64 for the pilot subcarrier indices in the 80 MHz RU(s) with a constant shift of −3584, for the pilot subcarrier indices in the 80 MHz RU(s) with a constant shift of −2560, for the pilot subcarrier indices in the 80 MHz RU(s) with a constant shift of −1536, for the pilot subcarrier indices in the 80 MHz RU(s) with a constant shift of −512, for the pilot subcarrier indices in the 80 MHz RU(s) with a constant shift of +512, for the pilot subcarrier indices in the 80 MHz RU(s) with a constant shift of +1536, the pilot subcarrier indices in the 80 MHz RU(s) with a constant shift of +2560, and the pilot subcarrier indices in the 80 MHz RU(s) with a constant shift of +3584. In Option-2, i=1:64 for the pilot subcarrier indices in the 160 MHz RU(s) with a constant shift of −3072, for the pilot subcarrier indices in the 160 MHz RU(s) with a constant shift of −1024, for the pilot subcarrier indices in the 160 MHz RU(s) with a constant shift of +1024, and the pilot subcarrier indices in the 160 MHz RU(s) with a constant shift of +3072. In Option-3, i=1:64 for the pilot subcarrier indices in the 320 MHz RU(s) with a constant shift of −2048 and the pilot subcarrier indices in the 320 MHz RU(s) with a constant shift of +2048.

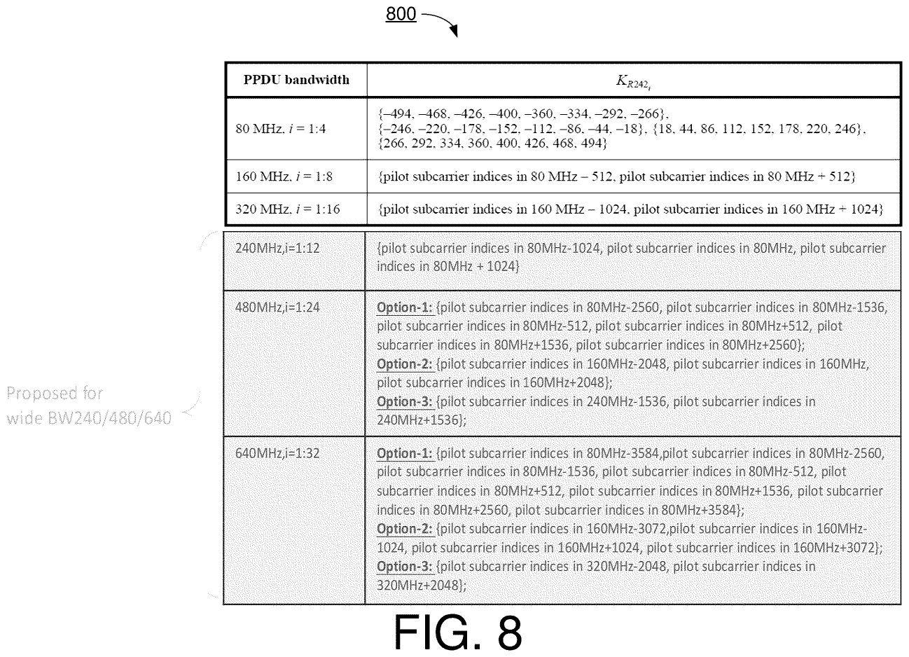

FIG. 8 illustrates an example design 800 under a proposed scheme in accordance with the present disclosure. Under the proposed scheme, pilot indices for transmission of a 242-tone RU in a wide bandwidth, such as BW240, BW480 and/or BW640, may be provided. Under the proposed scheme, the index i of pilot subcarrier indices for transmissions of 242-tone RUs in BW240 may be in a range of 1~12 (e.g., i=1:12) for the pilot subcarrier indices in the 80 MHz RU(s) with a constant shift of −1024, for the pilot subcarrier indices in the 80 MHz RU(s) centered around the center frequency, and the pilot subcarrier indices in the 80 MHz RU(s) with a constant shift of +1024.

Under the proposed scheme, the index i of pilot subcarrier indices for transmissions of 242-tone RUs in BW480 may be in a range of 1~24 (e.g., i=1:24) under the different options. In Option-1, i=1:24 for the pilot subcarrier indices in the 80 MHz RU(s) with a constant shift of −2560, for the pilot subcarrier indices in the 80 MHz RU(s) with a constant shift of −1536, for the pilot subcarrier indices in the 80 MHz RU(s) with a constant shift of −512, for the pilot subcarrier indices in the 80 MHz RU(s) with a constant shift of +512, for the pilot subcarrier indices in the 80 MHz RU(s) with a constant shift of +1536, and the pilot subcarrier indices in the 80 MHz RU(s) with a constant shift of +2560. In Option-2, i=1:24 for the pilot subcarrier indices in the 160 MHz RU(s) with a constant shift of −2048, for the pilot subcarrier indices in the 160 MHz RU(s) centered around the center frequency, and the pilot subcarrier indices in the 160 MHz RU(s) with a constant shift of +2048. In Option-3, i=1:24 for the pilot subcarrier indices in the 240 MHz RU(s) with a constant shift of −1536 and the pilot subcarrier indices in the 240 MHz RU(s) with a constant shift of +1536.

Under the proposed scheme, the index i of pilot subcarrier indices for transmissions of 242-tone RUs in BW640 may be in a range of 1~32 (e.g., i=1:32) under the different options. In Option-1, i=1:32 for the pilot subcarrier indices in the 80 MHz RU(s) with a constant shift of −3584, for the pilot subcarrier indices in the 80 MHz RU(s) with a constant shift of −2560, for the pilot subcarrier indices in the 80 MHz RU(s) with a constant shift of −1536, for the pilot subcarrier indices in the 80 MHz RU(s) with a constant shift of −512, for the pilot subcarrier indices in the 80 MHz RU(s) with a constant shift of +512, for the pilot subcarrier indices in the 80 MHz RU(s) with a constant shift of +1536, the pilot subcarrier indices in the 80 MHz RU(s) with a constant shift of +2560, and the pilot subcarrier indices in the 80 MHz RU(s) with a constant shift of +3584. In Option-2, i=1:32 for the pilot subcarrier indices in the 160 MHz RU(s) with a constant shift of −3072, for the pilot subcarrier indices in the 160 MHz RU(s) with a constant shift of −1024, for the pilot subcarrier indices in the 160 MHz RU(s) with a constant shift of +1024, and the pilot subcarrier indices in the 160 MHz RU(s) with a constant shift of +3072. In Option-3, i=1:32 for the pilot subcarrier indices in the 320 MHz RU(s) with a constant shift of −2048 and the pilot subcarrier indices in the 320 MHz RU(s) with a constant shift of +2048.

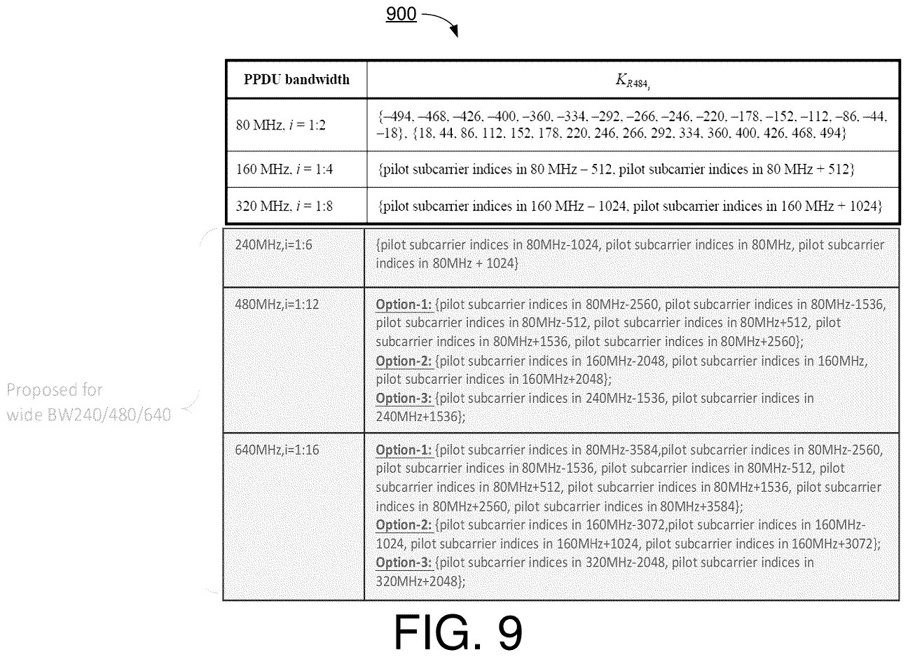

FIG. 9 illustrates an example design 900 under a proposed scheme in accordance with the present disclosure. Under the proposed scheme, pilot indices for transmission of a 484-tone RU in a wide bandwidth, such as BW240, BW480 and/or BW640, may be provided. Under the proposed scheme, the index i of pilot subcarrier indices for transmissions of 484-tone RUs in BW240 may be in a range of 1~6 (e.g., i=1:6) for the pilot subcarrier indices in the 80 MHz RU(s) with a constant shift of −1024, for the pilot subcarrier indices in the 80 MHz RU(s) centered around the center frequency, and the pilot subcarrier indices in the 80 MHz RU(s) with a constant shift of +1024.

Under the proposed scheme, the index i of pilot subcarrier indices for transmissions of 484-tone RUs in BW480 may be in a range of 1~12 (e.g., i=1:12) under the different options. In Option-1, i=1:12 for the pilot subcarrier indices in the 80 MHz RU(s) with a constant shift of −2560, for the pilot subcarrier indices in the 80 MHz RU(s) with a constant shift of −1536, for the pilot subcarrier indices in the 80 MHz RU(s) with a constant shift of −512, for the pilot subcarrier indices in the 80 MHz RU(s) with a constant shift of +512, for the pilot subcarrier indices in the 80 MHz RU(s) with a constant shift of +1536, and the pilot subcarrier indices in the 80 MHz RU(s) with a constant shift of +2560. In Option-2, i=1:12 for the pilot subcarrier indices in the 160 MHz RU(s) with a constant shift of −2048, for the pilot subcarrier indices in the 160 MHz RU(s) centered around the center frequency, and the pilot subcarrier indices in the 160 MHz RU(s) with a constant shift of +2048. In Option-3, i=1:12 for the pilot subcarrier indices in the 240 MHz RU(s) with a constant shift of −1536 and the pilot subcarrier indices in the 240 MHz RU(s) with a constant shift of +1536.

Under the proposed scheme, the index i of pilot subcarrier indices for transmissions of 484-tone RUs in BW640 may be in a range of 1~16 (e.g., i=1:16) under the different options. In Option-1, i=1:16 for the pilot subcarrier indices in the 80 MHz RU(s) with a constant shift of −3584, for the pilot subcarrier indices in the 80 MHz RU(s) with a constant shift of −2560, for the pilot subcarrier indices in the 80 MHz RU(s) with a constant shift of −1536, for the pilot subcarrier indices in the 80 MHz RU(s) with a constant shift of −512, for the pilot subcarrier indices in the 80 MHz RU(s) with a constant shift of +512, for the pilot subcarrier indices in the 80 MHz RU(s) with a constant shift of +1536, the pilot subcarrier indices in the 80 MHz RU(s) with a constant shift of +2560, and the pilot subcarrier indices in the 80 MHz RU(s) with a constant shift of +3584. In Option-2, i=1:16 for the pilot subcarrier indices in the 160 MHz RU(s) with a constant shift of −3072, for the pilot subcarrier indices in the 160 MHz RU(s) with a constant shift of −1024, for the pilot subcarrier indices in the 160 MHz RU(s) with a constant shift of +1024, and the pilot subcarrier indices in the 160 MHz RU(s) with a constant shift of +3072. In Option-3, i=1:16 for the pilot subcarrier indices in the 320 MHz RU(s) with a constant shift of −2048 and the pilot subcarrier indices in the 320 MHz RU(s) with a constant shift of +2048.

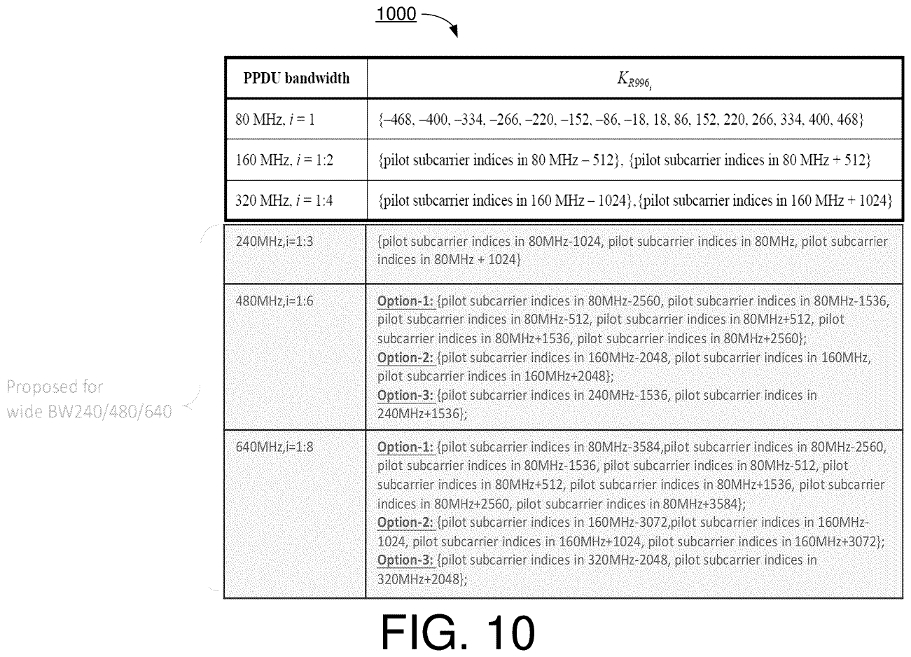

FIG. 10 illustrates an example design 1000 under a proposed scheme in accordance with the present disclosure. Under the proposed scheme, pilot indices for transmission of a 996-tone RU in a wide bandwidth, such as BW240, BW480 and/or BW640, may be provided. Under the proposed scheme, the index i of pilot subcarrier indices for transmissions of 996-tone RUs in BW240 may be in a range of 1~3 (e.g., i=1:3) for the pilot subcarrier indices in the 80 MHz RU(s) with a constant shift of −1024, for the pilot subcarrier indices in the 80 MHz RU(s) centered around the center frequency, and the pilot subcarrier indices in the 80 MHz RU(s) with a constant shift of +1024.

Under the proposed scheme, the index i of pilot subcarrier indices for transmissions of 996-tone RUs in BW480 may be in a range of 1~6 (e.g., i=1:6) under the different options. In Option-1, i=1:6 for the pilot subcarrier indices in the 80 MHz RU(s) with a constant shift of −2560, for the pilot subcarrier indices in the 80 MHz RU(s) with a constant shift of −1536, for the pilot subcarrier indices in the 80 MHz RU(s) with a constant shift of −512, for the pilot subcarrier indices in the 80 MHz RU(s) with a constant shift of +512, for the pilot subcarrier indices in the 80 MHz RU(s) with a constant shift of +1536, and the pilot subcarrier indices in the 80 MHz RU(s) with a constant shift of +2560. In Option-2, i=1:6 for the pilot subcarrier indices in the 160 MHz RU(s) with a constant shift of −2048, for the pilot subcarrier indices in the 160 MHz RU(s) centered around the center frequency, and the pilot subcarrier indices in the 160 MHz RU(s) with a constant shift of +2048. In Option-3, i=1:6 for the pilot subcarrier indices in the 240 MHz RU(s) with a constant shift of −1536 and the pilot subcarrier indices in the 240 MHz RU(s) with a constant shift of +1536.

Under the proposed scheme, the index i of pilot subcarrier indices for transmissions of 996-tone RUs in BW640 may be in a range of 1~8 (e.g., i=1:8) under the different options. In Option-1, i=1:8 for the pilot subcarrier indices in the 80 MHz RU(s) with a constant shift of −3584, for the pilot subcarrier indices in the 80 MHz RU(s) with a constant shift of −2560, for the pilot subcarrier indices in the 80 MHz RU(s) with a constant shift of −1536, for the pilot subcarrier indices in the 80 MHz RU(s) with a constant shift of −512, for the pilot subcarrier indices in the 80 MHz RU(s) with a constant shift of +512, for the pilot subcarrier indices in the 80 MHz RU(s) with a constant shift of +1536, the pilot subcarrier indices in the 80 MHz RU(s) with a constant shift of +2560, and the pilot subcarrier indices in the 80 MHz RU(s) with a constant shift of +3584. In Option-2, i=1:8 for the pilot subcarrier indices in the 160 MHz RU(s) with a constant shift of −3072, for the pilot subcarrier indices in the 160 MHz RU(s) with a constant shift of −1024, for the pilot subcarrier indices in the 160 MHz RU(s) with a constant shift of +1024, and the pilot subcarrier indices in the 160 MHz RU(s) with a constant shift of +3072. In Option-3, i=1:8 for the pilot subcarrier indices in the 320 MHz RU(s) with a constant shift of −2048 and the pilot subcarrier indices in the 320 MHz RU(s) with a constant shift of +2048.

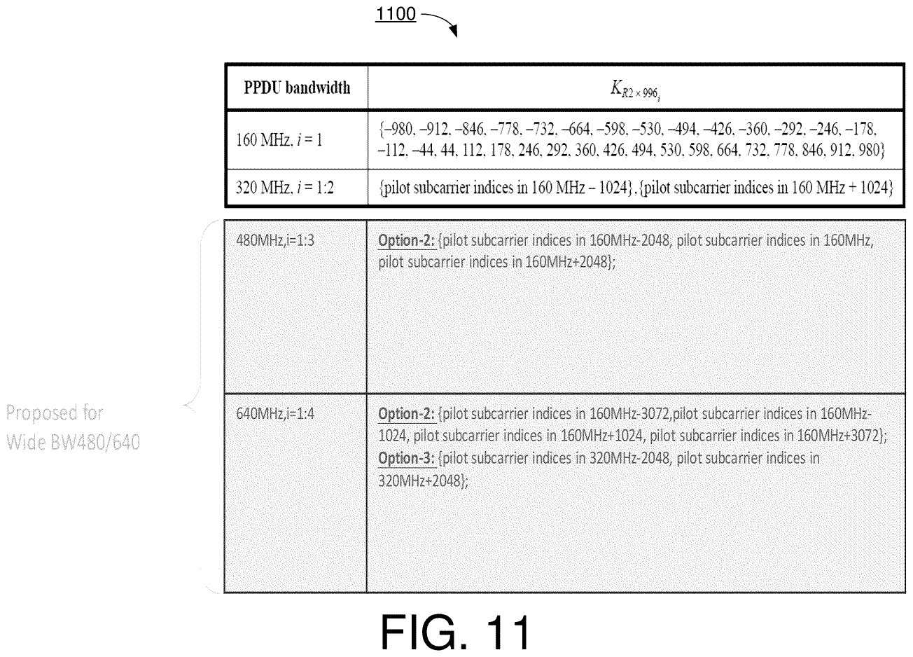

FIG. 11 illustrates an example design 1100 under a proposed scheme in accordance with the present disclosure. Under the proposed scheme, pilot indices for transmission of a 2×996-tone RU in a wide bandwidth, such as BW480 and/or BW640, may be provided. Under the proposed scheme, the index i of pilot subcarrier indices for transmissions of 2×996-tone RUs in BW480 may be in a range of 1~3 (e.g., i=1:3) for the pilot subcarrier indices in the 160 MHz RU(s) with a constant shift of −1024, for the pilot subcarrier indices in the 160 MHz RU(s) centered around the center frequency, and the pilot subcarrier indices in the 160 MHz RU(s) with a constant shift of +1024.

Under the proposed scheme, the index i of pilot subcarrier indices for transmissions of 2×996-tone RUs in BW640 may be in a range of 1~4 (e.g., i=1:4) under the different options. In Option-2, i=1:4 for the pilot subcarrier indices in the 160 MHz RU(s) with a constant shift of −3072, for the pilot subcarrier indices in the 160 MHz RU(s) with a constant shift of −1024, for the pilot subcarrier indices in the 160 MHz RU(s) with a constant shift of +1024, and the pilot subcarrier indices in the 160 MHz RU(s) with a constant shift of +3072. In Option-3, i=1:4 for the pilot subcarrier indices in the 320 MHz RU(s) with a constant shift of −2048 and the pilot subcarrier indices in the 320 MHz RU(s) with a constant shift of +2048.

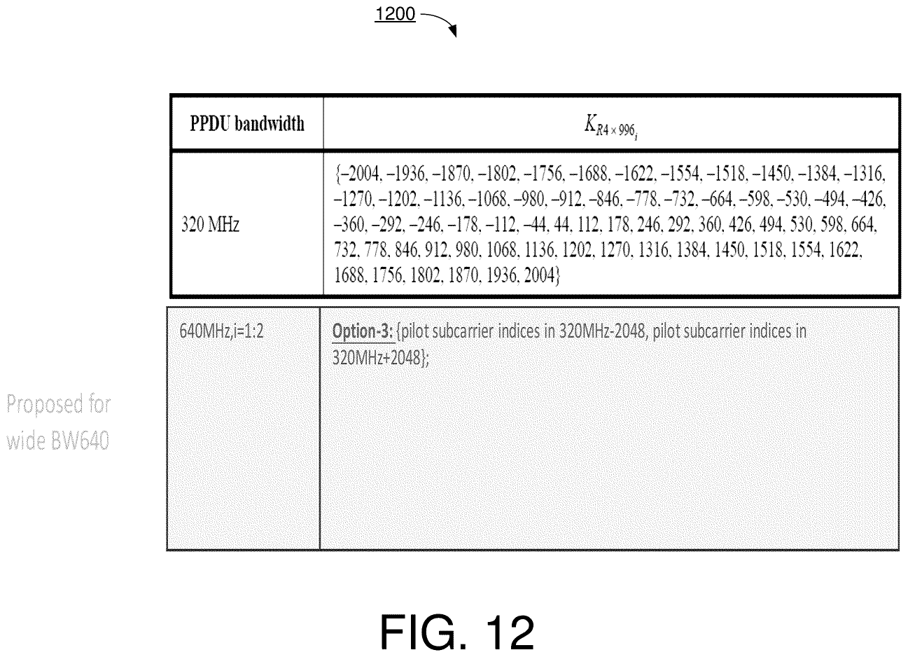

FIG. 12 illustrates an example design 1200 under a proposed scheme in accordance with the present disclosure. Under the proposed scheme, pilot indices for transmission of a 4×996-tone RU in a wide bandwidth, such as BW640, may be provided. Under the proposed scheme, the index i of pilot subcarrier indices for transmissions of 4×996-tone RUs in BW640 may be in a range of 1~2 (e.g., i=1:2) for the pilot subcarrier indices in the 320 MHz RU(s) with a constant shift of −2048 and the pilot subcarrier indices in the 320 MHz RU(s) with a constant shift of +2048.

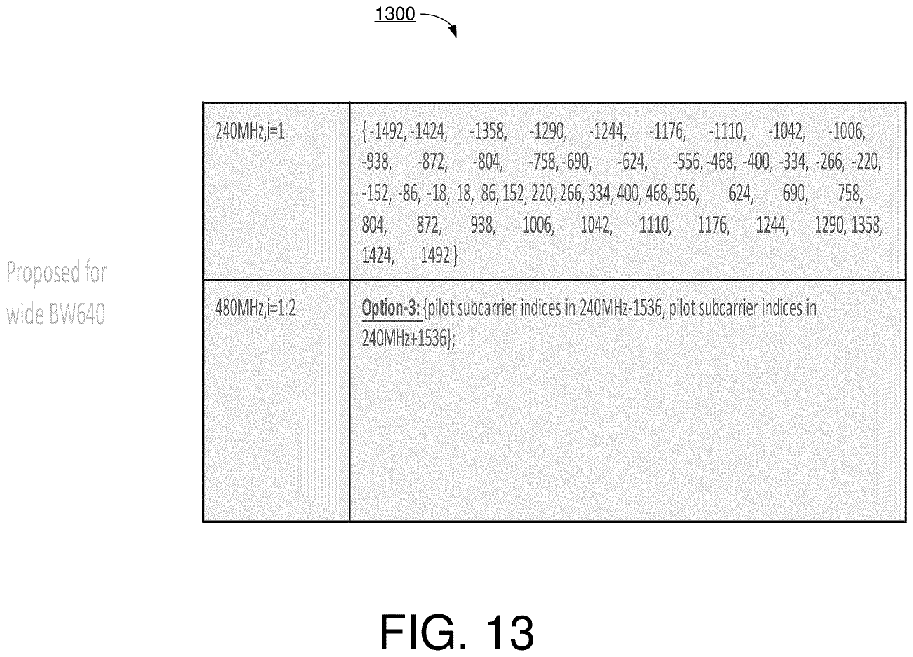

FIG. 13 illustrates an example design 1300 under a proposed scheme in accordance with the present disclosure. Under the proposed scheme, pilot indices for transmission of a 3×996-tone RU in a wide bandwidth, such as BW240 and/or BW480, may be provided. Under the proposed scheme, the index i of pilot subcarrier indices for transmissions of 3×996-tone RUs in BW240 may be in a range of 1~1 (e.g., i=1:1) for the pilot subcarrier indices in the 240 MHz RU(s) and be expressed as: {−1492, −1424, −1358, −1290, −1244, −1176, −1110, −1042, −1006, −938, −-872, −804, −758, −690, −624, −556, −468, −400, −334, −266, −220, −152, −86, −18, 18, 86, 152, 220, 266, 334, 400, 468, 556, 624, 690, 758, 804, 872, 938, 1006, 1042, 1110, 1176, 1244, 1290, 1358, 1424, 1492}. Under the proposed scheme, the index i of pilot subcarrier indices for transmissions of 3×996-tone RUs in BW480 may be in a range of 1~2 (e.g., i=1:2) for the pilot subcarrier indices in the 240 MHz RU(s) with a constant shift of −1536 and the pilot subcarrier indices in the 240 MHz RU(s) with a constant shift of +1536.

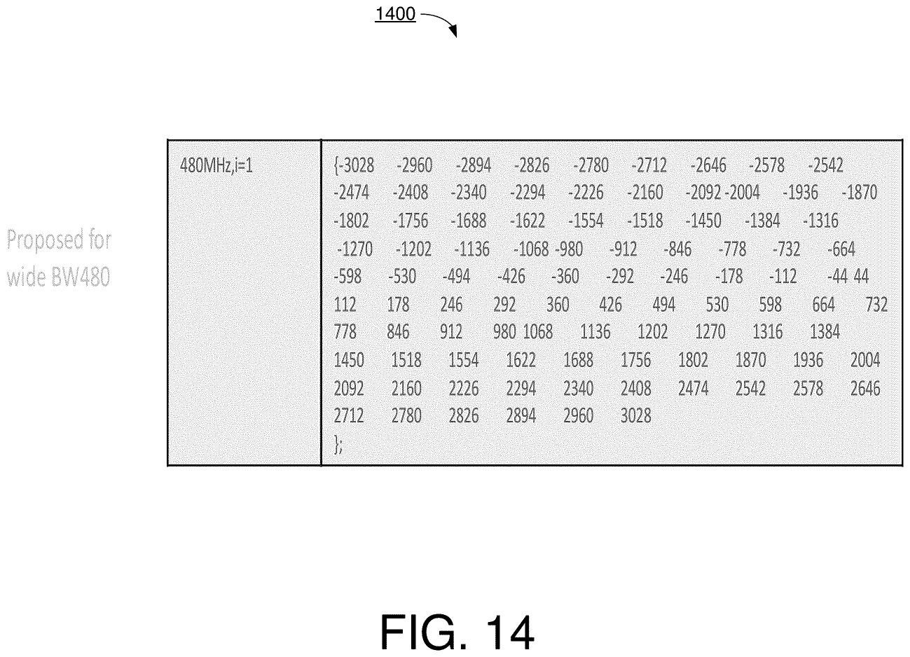

FIG. 14 illustrates an example design 1400 under a proposed scheme in accordance with the present disclosure. Under the proposed scheme, pilot indices for transmission of a 6×996-tone RU in a wide bandwidth, such as BW480, may be provided. Under the proposed scheme, the index i of pilot subcarrier indices for transmissions of 6×996-tone RUs in BW480 may be in a range of 1~1 (e.g., i=1:1) for the pilot subcarrier indices in the 480 MHz RU(s) and be expressed as: {−3028, −2960, −2894, −2826, −2780, −2712, −2646, −2578, −2542, −2474, −2408, −2340, −2294, −2226, −2160, −2092, −2004, −1936, −1870, −1802, −1756, −1688, −1622, −1554, −1518, −1450, −1384, −1316, −1270, −1202, −1136, −1068, −980, −912, −846, −778, −732, −664, −598, −530, −494, −426, −360, −292, −246, −178, −112, −44, 44, 112, 178, 246, 292, 360, 426, 494, 530, 598, 664, 732, 778, 846, 912, 980, 1068, 1136, 1202, 1270, 1316, 1384, 1450, 1518, 1554, 1622, 1688, 1756, 1802, 1870, 1936, 2004, 2092, 2160, 2226, 2294, 2340, 2408, 2474, 2542, 2578, 2646, 2712, 2780, 2826, 2894, 2960, 3028}.

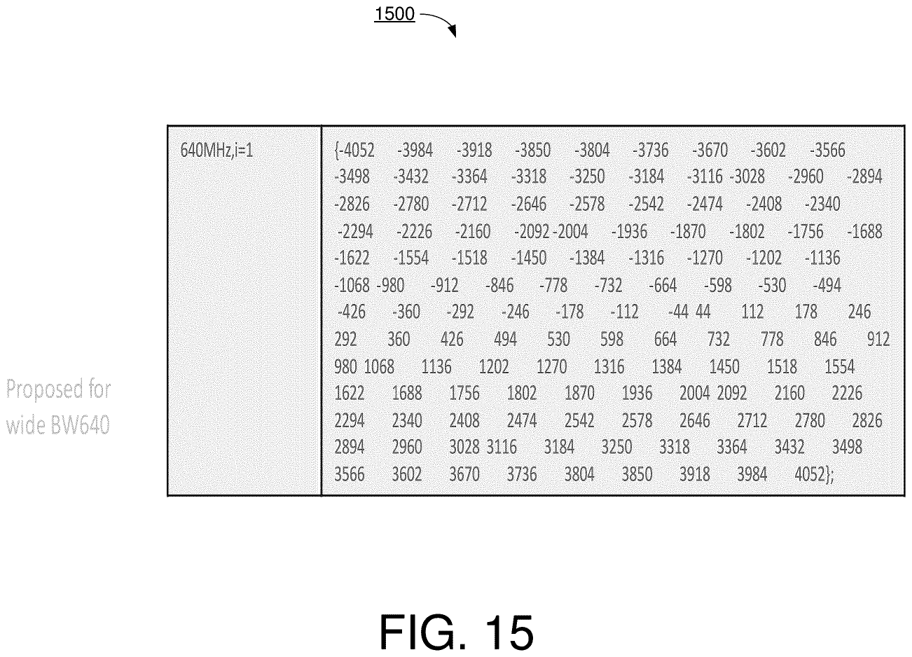

FIG. 15 illustrates an example design 1500 under a proposed scheme in accordance with the present disclosure. Under the proposed scheme, pilot indices for transmission of an 8×996-tone RU in a wide bandwidth, such as BW640, may be provided. Under the proposed scheme, the index i of pilot subcarrier indices for transmissions of 8×996-tone RUs in BW640 may be in a range of 1~1 (e.g., i=1:1) for the pilot subcarrier indices in the 640 MHz RU(s) and be expressed as: {−4052, −3984, −3918, −3850, −3804, −3736, −3670, −3602, −3566, −3498, −3432, −3364, −3318, −3250, −3184, −3116, −3028, −2960, −2894, −2826, −2780, −2712, −2646, −2578, −2542, −2474, −2408, −2340, −2294, −2226, −2160, −2092, −2004, −1936, −1870, −1802, −1756, −1688, −1622, −1554, −1518, −1450, −1384, −1316, −1270, −1202, −1136, −1068, −980, −912, −846, −778, −732, −664, −598, −530, −494, −426, −360, −292, −246, −178, −112, −44, 44, 112, 178, 246, 292, 360, 426, 494, 530, 598, 664, 732, 778, 846, 912, 980, 1068, 1136, 1202, 1270, 1316, 1384, 1450, 1518, 1554, 1622, 1688, 1756, 1802, 1870, 1936, 2004, 2092, 2160, 2226, 2294, 2340, 2408, 2474, 2542, 2578, 2646, 2712, 2780, 2826, 2894, 2960, 3028, 3116, 3184, 3250, 3318, 3364, 3432, 3498, 3566, 3602, 3670, 3736, 3804, 3850, 3918, 3984, 4052}.

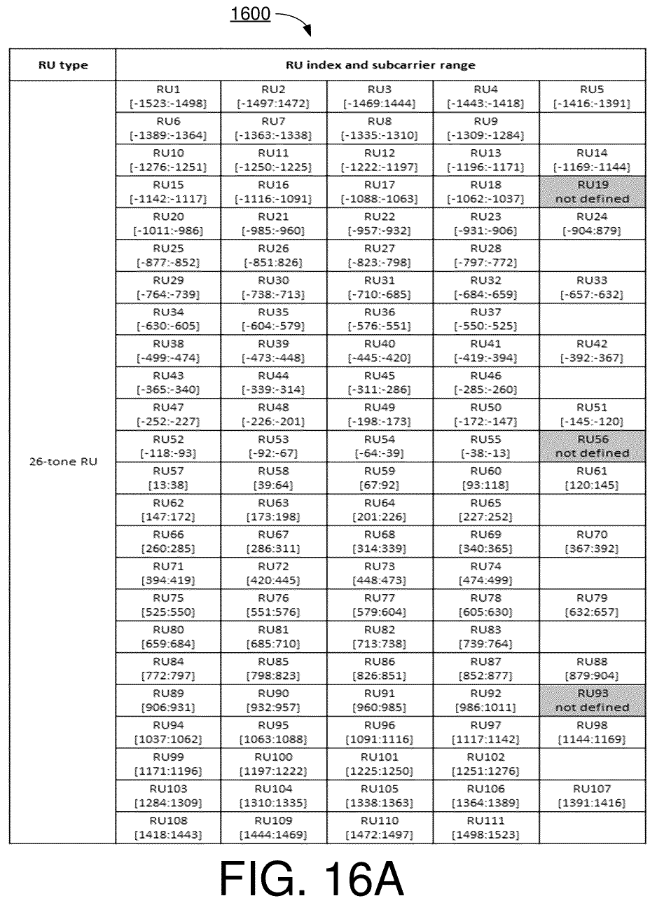

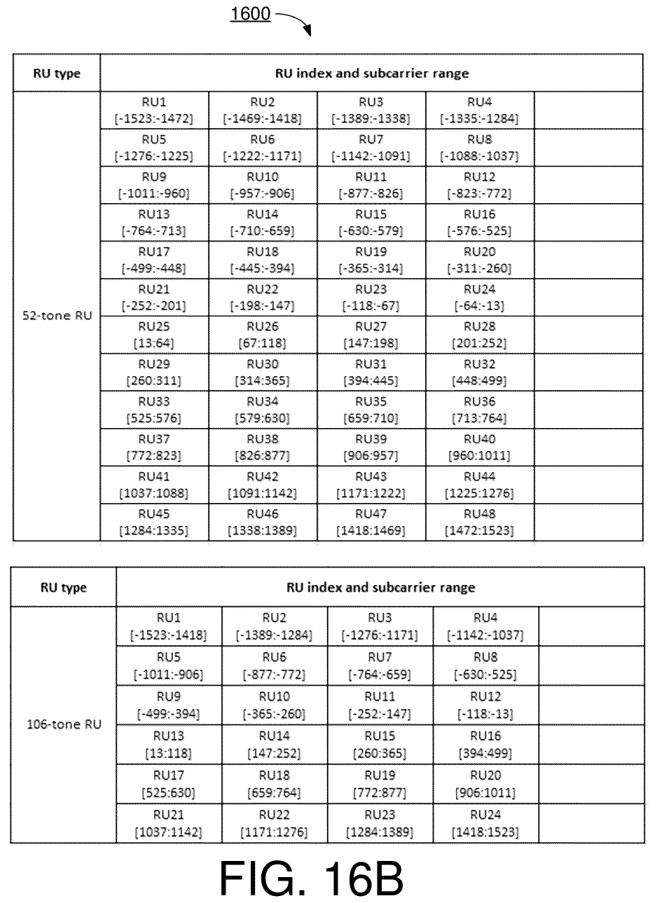

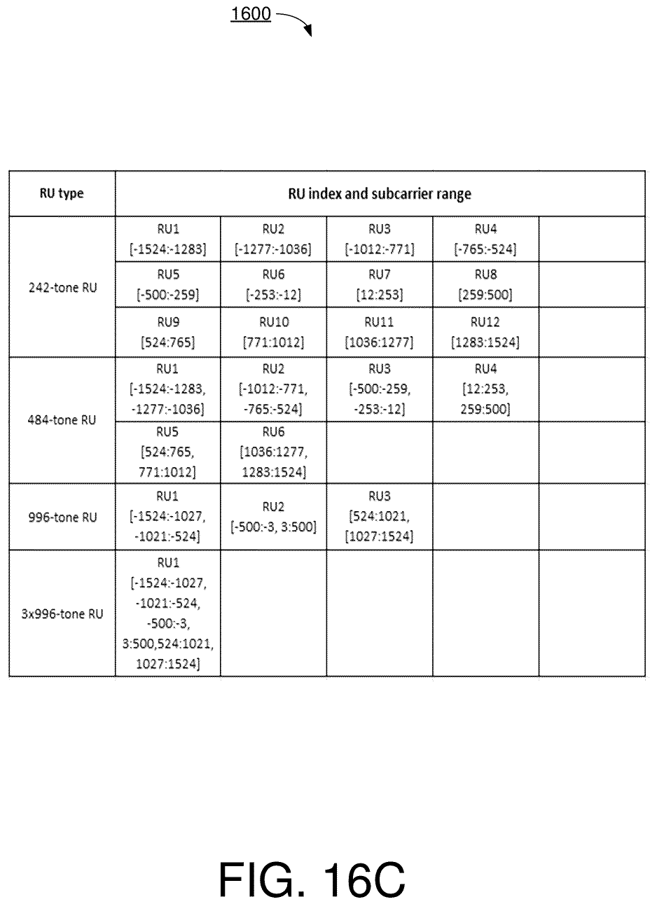

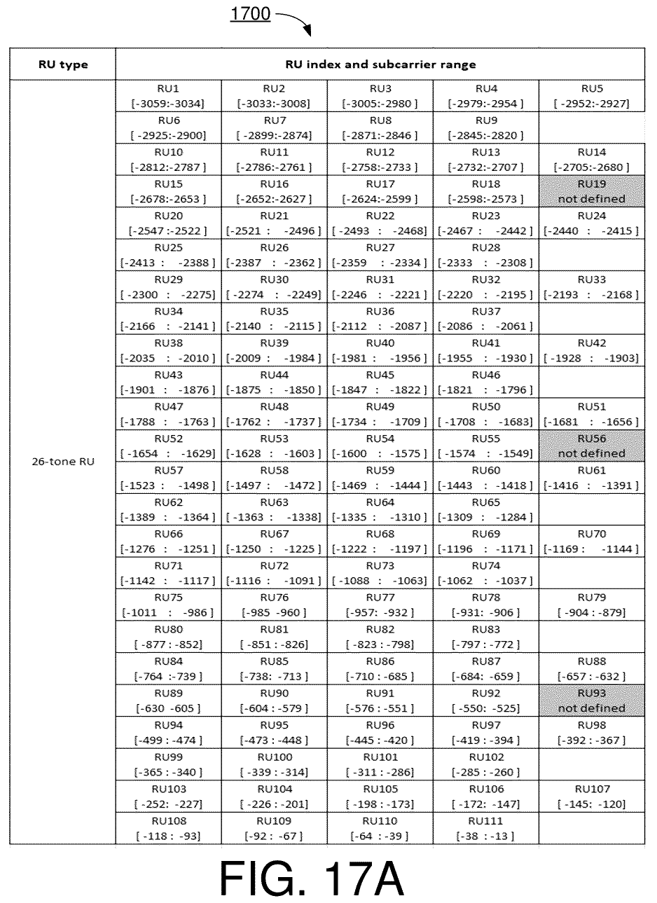

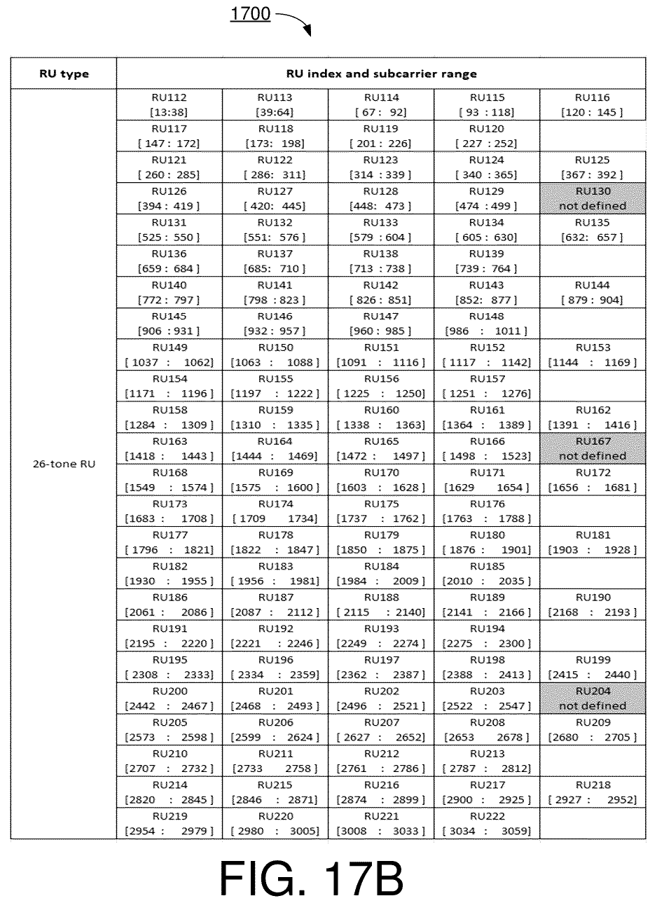

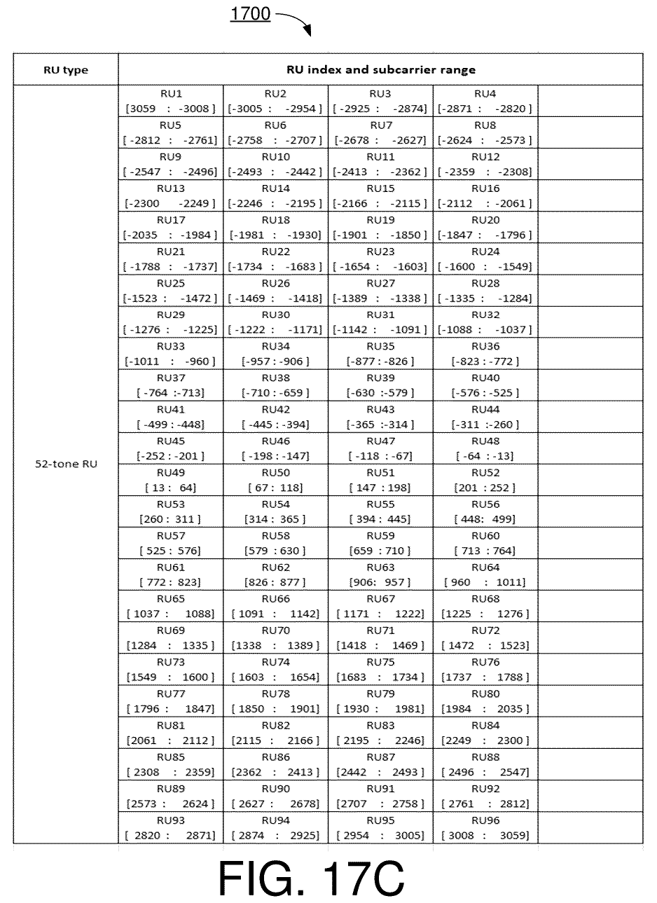

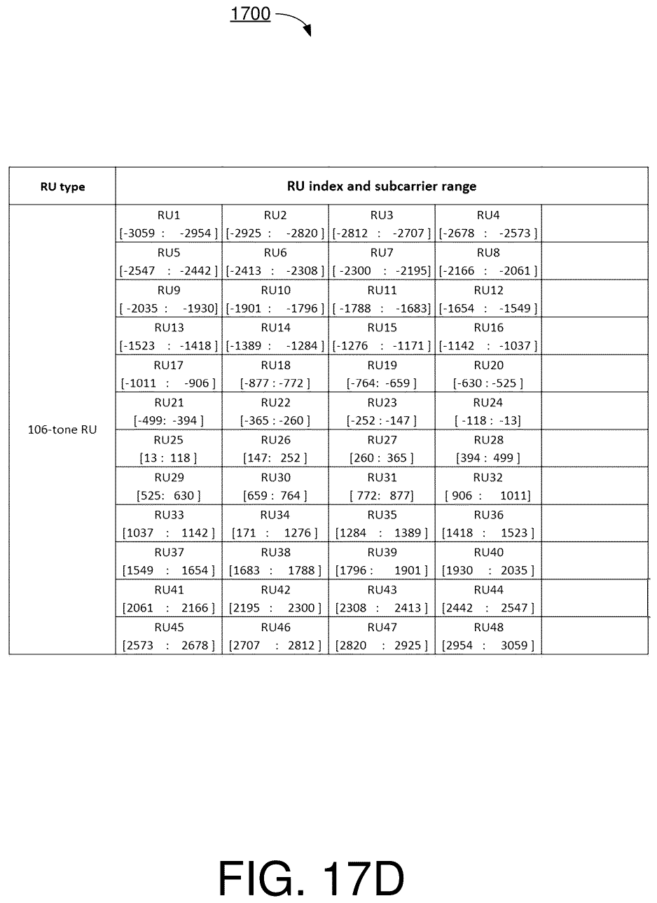

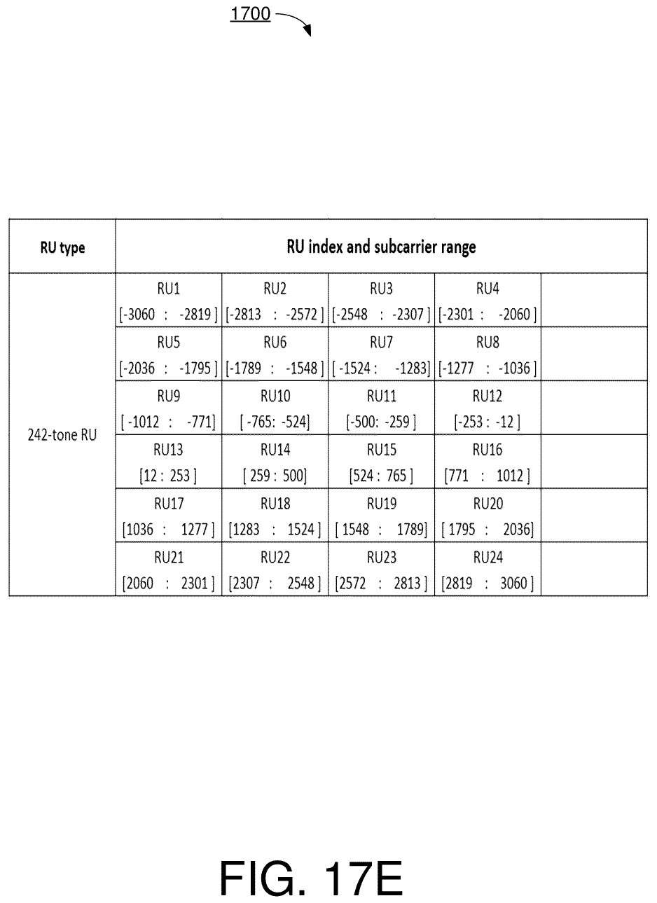

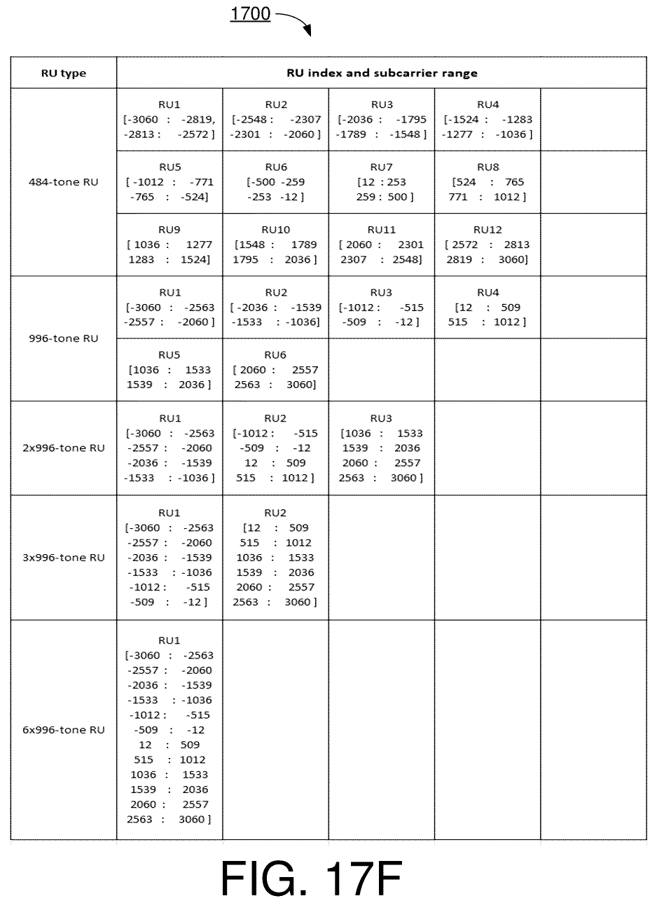

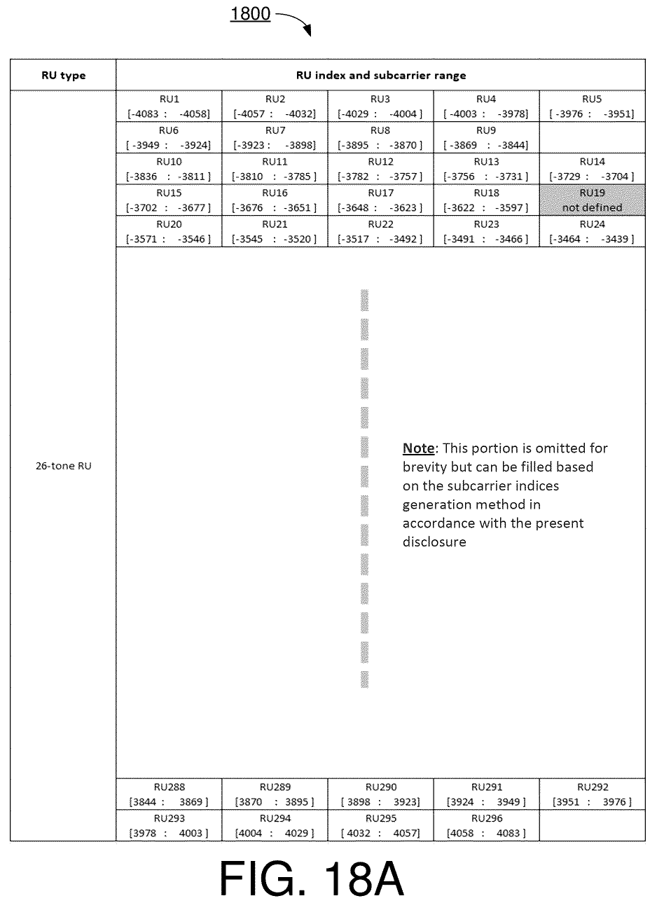

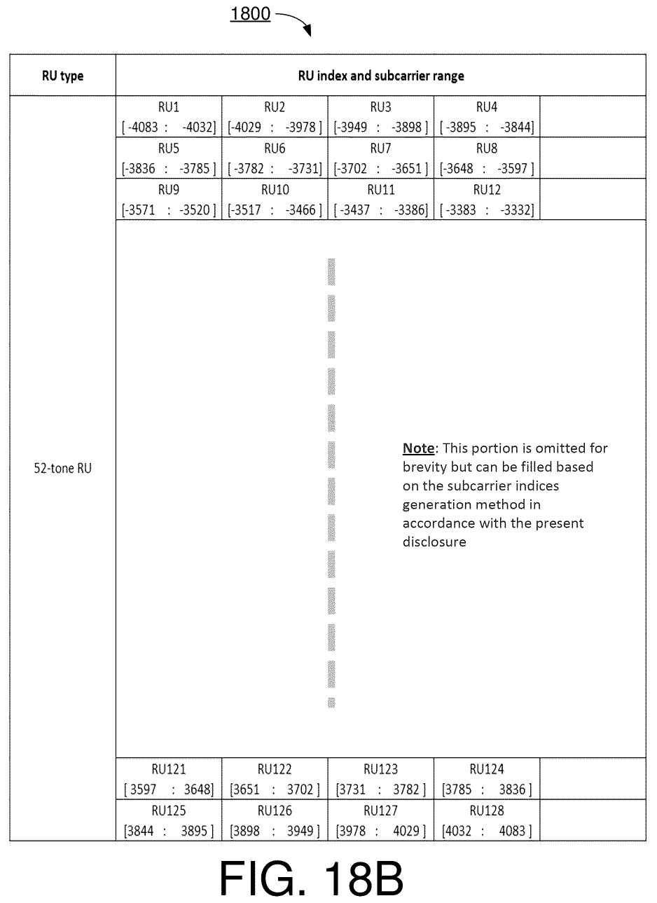

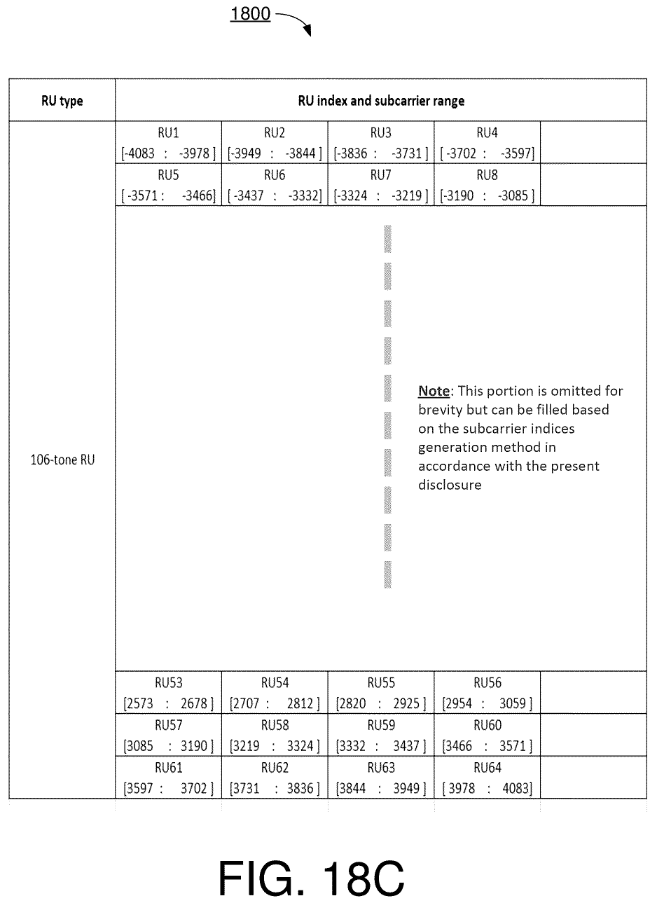

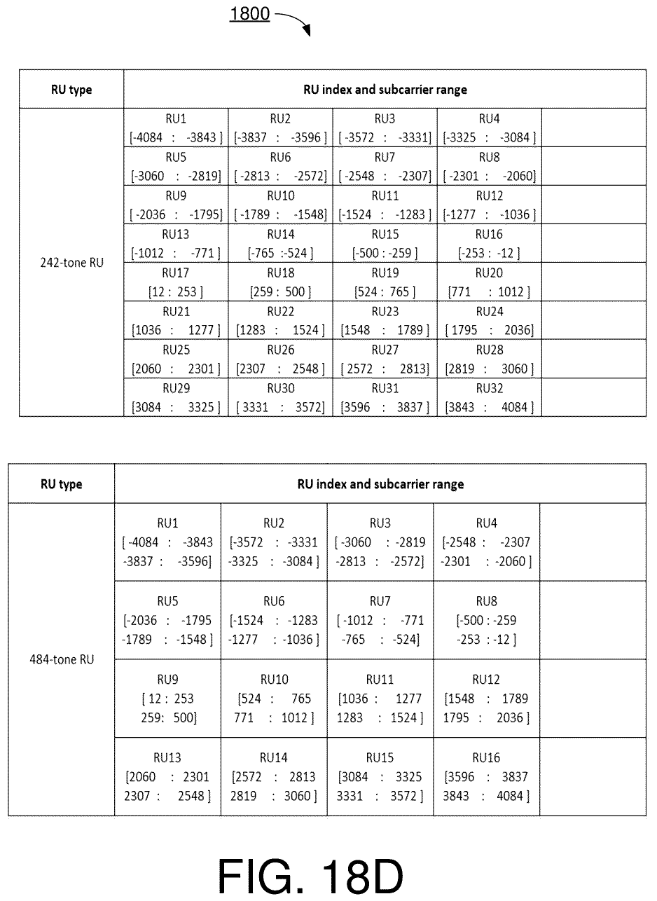

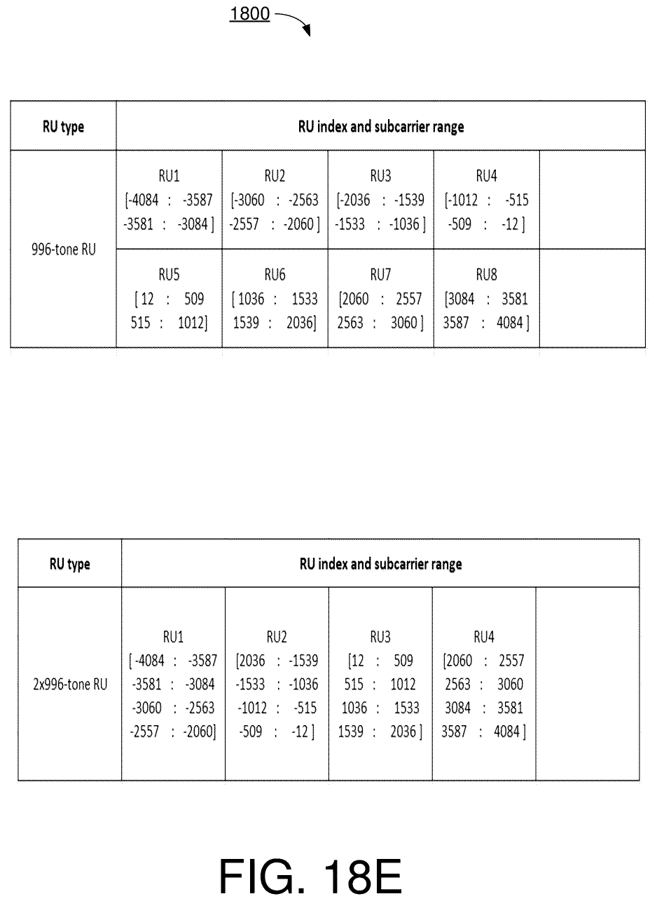

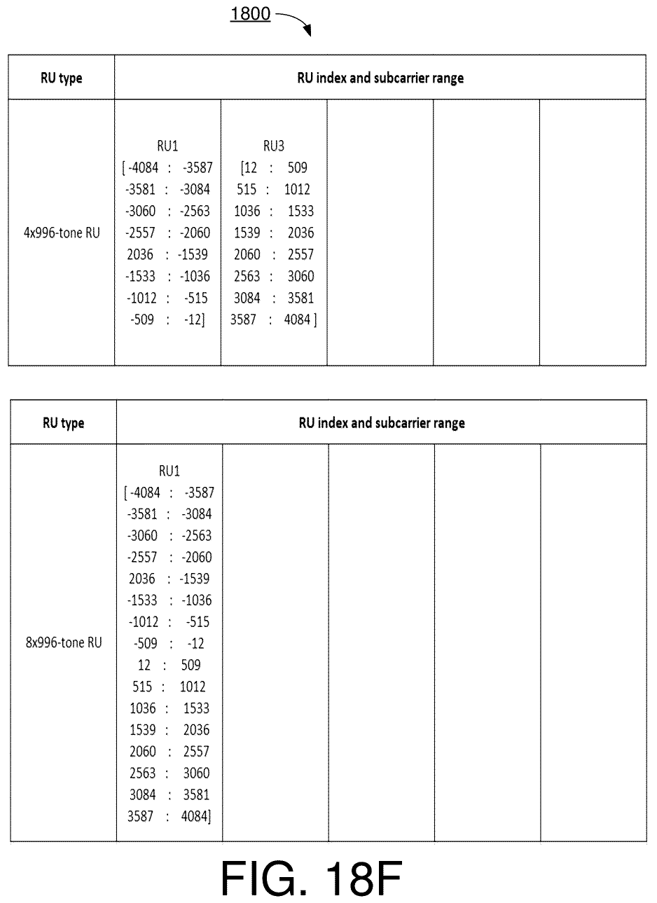

Each of FIG. 16A~FIG. 16C illustrates a portion of an example design 1600 of data and pilot subcarrier indices for the 240 MHz bandwidth under a proposed scheme in accordance with the present disclosure. Each of FIG. 17A~FIG. 17F illustrates a portion of an example design 1700 of data and pilot subcarrier indices for the 480 MHz bandwidth under a proposed scheme in accordance with the present disclosure. Each of FIG. 18A~FIG. 18F illustrates a portion of an example design 1800 of data and pilot subcarrier indices for the 640 MHz bandwidth under a proposed scheme in accordance with the present disclosure. It is noteworthy that, to avoid cluttering of the figures and in the interest of brevity, some of the entries in FIG. 18A~FIG. 18C are omitted although they may be filled in based on the proposed scheme(s) described above.

### Illustrative Implementations

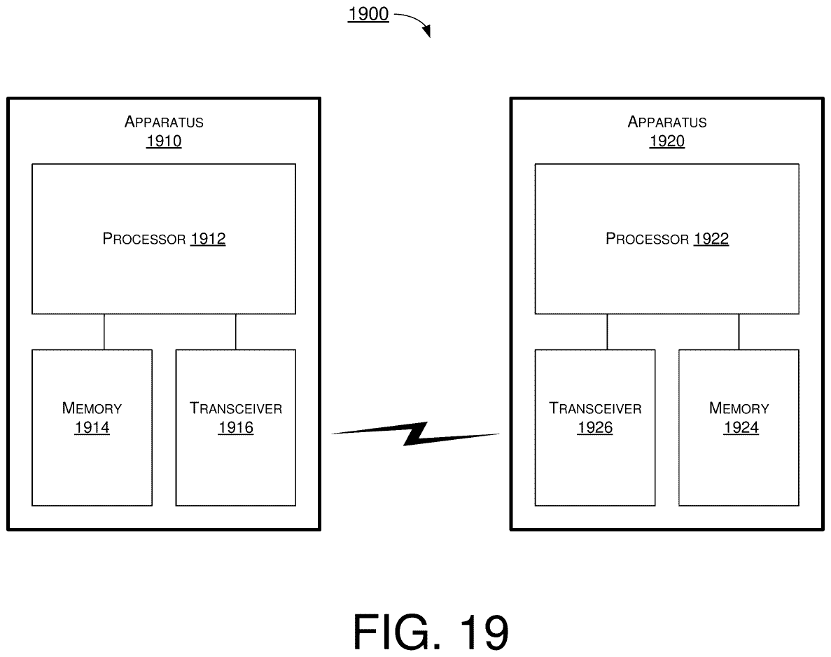

FIG. 19 illustrates an example system 1900 having at least an example apparatus 1910 and an example apparatus 1920 in accordance with an implementation of the present disclosure. Each of apparatus 1910 and apparatus 1920 may perform various functions to implement schemes, techniques, processes and methods described herein pertaining to designs of data and pilot subcarrier indices of wide bandwidth RUs for next-generation WLANs, including the various schemes described above with respect to various proposed designs, concepts, schemes, systems and methods described above as well as processes described below. For instance, apparatus 1910 may be implemented in STA 110 and apparatus 1920 may be implemented in STA 120, or vice versa.

Each of apparatus 1910 and apparatus 1920 may be a part of an electronic apparatus, which may be a non-AP STA or an AP STA, such as a portable or mobile apparatus, a wearable apparatus, a wireless communication apparatus or a computing apparatus. When implemented in a STA, each of apparatus 1910 and apparatus 1920 may be implemented in a smartphone, a smart watch, a personal digital assistant, a digital camera, or a computing equipment such as a tablet computer, a laptop computer or a notebook computer. Each of apparatus 1910 and apparatus 1920 may also be a part of a machine type apparatus, which may be an IoT apparatus such as an immobile or a stationary apparatus, a home apparatus, a wire communication apparatus or a computing apparatus. For instance, each of apparatus 1910 and apparatus 1920 may be implemented in a smart thermostat, a smart fridge, a smart door lock, a wireless speaker or a home control center. When implemented in or as a network apparatus, apparatus 1910 and/or apparatus 1920 may be implemented in a network node, such as an AP in a WLAN.

In some implementations, each of apparatus 1910 and apparatus 1920 may be implemented in the form of one or more integrated-circuit (IC) chips such as, for example and without limitation, one or more single-core processors, one or more multi-core processors, one or more reduced-instruction set computing (RISC) processors, or one or more complex-instruction-set-computing (CISC) processors. In the various schemes described above, each of apparatus 1910 and apparatus 1920 may be implemented in or as a STA or an AP. Each of apparatus 1910 and apparatus 1920 may include at least some of those components shown in FIG. 19 such as a processor 1912 and a processor 1922, respectively, for example. Each of apparatus 1910 and apparatus 1920 may further include one or more other components not pertinent to the proposed scheme of the present disclosure (e.g., internal power supply, display device and/or user interface device), and, thus, such component(s) of apparatus 1910 and apparatus 1920 are neither shown in FIG. 19 nor described below in the interest of simplicity and brevity.

In one aspect, each of processor 1912 and processor 1922 may be implemented in the form of one or more single-core processors, one or more multi-core processors, one or more RISC processors or one or more CISC processors. That is, even though a singular term “a processor” is used herein to refer to processor 1912 and processor 1922, each of processor 1912 and processor 1922 may include multiple processors in some implementations and a single processor in other implementations in accordance with the present disclosure. In another aspect, each of processor 1912 and processor 1922 may be implemented in the form of hardware (and, optionally, firmware) with electronic components including, for example and without limitation, one or more transistors, one or more diodes, one or more capacitors, one or more resistors, one or more inductors, one or more memristors and/or one or more varactors that are configured and arranged to achieve specific purposes in accordance with the present disclosure. In other words, in at least some implementations, each of processor 1912 and processor 1922 is a special-purpose machine specifically designed, arranged and configured to perform specific tasks including those pertaining to designs of data and pilot subcarrier indices of wide bandwidth RUs for next-generation WLANs in accordance with various implementations of the present disclosure.

In some implementations, apparatus 1910 may also include a transceiver 1916 coupled to processor 1912. Transceiver 1916 may include a transmitter capable of wirelessly transmitting and a receiver capable of wirelessly receiving data. In some implementations, apparatus 1920 may also include a transceiver 1926 coupled to processor 1922. Transceiver 1926 may include a transmitter capable of wirelessly transmitting and a receiver capable of wirelessly receiving data. It is noteworthy that, although transceiver 1916 and transceiver 1926 are illustrated as being external to and separate from processor 1912 and processor 1922, respectively, in some implementations, transceiver 1916 may be an integral part of processor 1912 as a system on chip (SoC), and transceiver 1926 may be an integral part of processor 1922 as a SoC.

In some implementations, apparatus 1910 may further include a memory 1914 coupled to processor 1912 and capable of being accessed by processor 1912 and storing data therein. In some implementations, apparatus 1920 may further include a memory 1924 coupled to processor 1922 and capable of being accessed by processor 1922 and storing data therein. Each of memory 1914 and memory 1924 may include a type of random-access memory (RAM) such as dynamic RAM (DRAM), static RAM (SRAM), thyristor RAM (T-RAM) and/or zero-capacitor RAM (Z-RAM). Alternatively, or additionally, each of memory 1914 and memory 1924 may include a type of read-only memory (ROM) such as mask ROM, programmable ROM (PROM), erasable programmable ROM (EPROM) and/or electrically erasable programmable ROM (EEPROM). Alternatively, or additionally, each of memory 1914 and memory 1924 may include a type of non-volatile random-access memory (NVRAM) such as flash memory, solid-state memory, ferroelectric RAM (FeRAM), magnetoresistive RAM (MRAM) and/or phase-change memory.

Each of apparatus 1910 and apparatus 1920 may be a communication entity capable of communicating with each other using various proposed schemes in accordance with the present disclosure. For illustrative purposes and without limitation, a description of capabilities of apparatus 1910, as STA 110, and apparatus 1920, as STA 120, is provided below. It is noteworthy that, although a detailed description of capabilities, functionalities and/or technical features of apparatus 1920 is provided below, the same may be applied to apparatus 1910 although a detailed description thereof is not provided solely in the interest of brevity. It is also noteworthy that, although the example implementations described below are provided in the context of WLAN, the same may be implemented in other types of networks.

Under various proposed schemes pertaining to designs of data and pilot subcarrier indices of wide bandwidth RUs for next-generation WLANs in accordance with the present disclosure, with apparatus 1910 implemented in or as STA 110 and apparatus 1920 implemented in or as STA 120 in network environment 100, processor 1912 of apparatus 1910 may generate one or more RUs with a SCS of 78.125 kHz and with a constant shift applied to at least a portion of data and pilot subcarrier indices of the one or more RUs. Moreover, processor 1912 may wirelessly transmit, via transceiver 1916, the one or more RUs in a wide bandwidth greater than 80 MHz (e.g., transmitting to and/or receiving from apparatus 1920).

In some implementations, in transmitting the one or more RUs, processor 1912 may transmit the one or more RUs in a 240 MHz, 480 MHz or 640 MHz bandwidth.

In some implementations, the wide bandwidth may include a 240 MHz bandwidth. In such cases, in generating the one or more RUs, processor 1912 may perform certain operations, including: (a) generating a first group of data and pilot subcarrier indices of one or more 80 MHz RUs around a center frequency of the 240 MHz bandwidth; (b) generating a second group of data and pilot subcarrier indices of one or more 80 MHz RUs to a left side of the center frequency by a shift of −1024; and (c) generating a third group of data and pilot subcarrier indices of one or more 80 MHz RUs to a right side of the center frequency by a shift of +1024.

In some implementations, the wide bandwidth may include a 480 MHz bandwidth. In such cases, in generating the one or more RUs, processor 1912 may perform certain operations, including: (a) generating a first group of data and pilot subcarrier indices of one or more 80 MHz RUs to a left side of a center frequency of the 480 MHz bandwidth by a shift of −2560; (b) generating a second group of data and pilot subcarrier indices of one or more 80 MHz RUs to the left side of the center frequency by a shift of −1536; (c) generating a third group of data and pilot subcarrier indices of one or more 80 MHz RUs to the left side of the center frequency by a shift of −512; (d) generating a fourth group of data and pilot subcarrier indices of one or more 80 MHz RUs to a right side of the center frequency by a shift of +512; (e) generating a fifth group of data and pilot subcarrier indices of one or more 80 MHz RUs to the right side of the center frequency by a shift of +1536; and (f) generating a sixth group of data and pilot subcarrier indices of one or more 80 MHz RUs to the right side of the center frequency by a shift of +2560.

In some implementations, the wide bandwidth may include a 480 MHz bandwidth. In such cases, in generating the one or more RUs, processor 1912 may perform certain operations, including: (a) generating a first group of data and pilot subcarrier indices of one or more 160 MHz RUs around a center frequency of the 480 MHz bandwidth; (b) generating a second group of data and pilot subcarrier indices of one or more 160 MHz RUs to a left side of the center frequency by a shift of −2048; and (c) generating a third group of data and pilot subcarrier indices of one or more 160 MHz RUs to a right side of the center frequency by a shift of +2048.

In some implementations, the wide bandwidth may include a 480 MHz bandwidth. In such cases, in generating the one or more RUs, processor 1912 may perform certain operations, including: (a) generating a first group of data and pilot subcarrier indices of one or more 240 MHz RUs to a left side of a center frequency of the 480 MHz bandwidth by a shift of −1536; and (b) generating a second group of data and pilot subcarrier indices of one or more 240 MHz RUs to a right side of the center frequency by a shift of +1536.

In some implementations, the wide bandwidth may include a 640 MHz bandwidth. In such cases, in generating the one or more RUs, processor 1912 may perform certain operations, including: (a) generating a first group of data and pilot subcarrier indices of one or more 80 MHz RUs to a left side of a center frequency of the 640 MHz bandwidth by a shift of −3584; (b) generating a second group of data and pilot subcarrier indices of one or more 80 MHz RUs to the left side of the center frequency by a shift of −2560; (c) generating a third group of data and pilot subcarrier indices of one or more 80 MHz RUs to the left side of the center frequency by a shift of −1536; (d) generating a fourth group of data and pilot subcarrier indices of one or more 80 MHz RUs to the left side of the center frequency by a shift of −512; (e) generating a fifth group of data and pilot subcarrier indices of one or more 80 MHz RUs to a right side of the center frequency by a shift of +512; (f) generating a sixth group of data and pilot subcarrier indices of one or more 80 MHz RUs to the right side of the center frequency by a shift of +1536; (g) generating a seventh group of data and pilot subcarrier indices of one or more 80 MHz RUs to the right side of the center frequency by a shift of +2560; and (h) generating an eighth group of data and pilot subcarrier indices of one or more 80 MHz RUs to the right side of the center frequency by a shift of +3584.

In some implementations, the wide bandwidth may include a 640 MHz bandwidth. In such cases, in generating the one or more RUs, processor 1912 may perform certain operations, including: (a) generating a first group of data and pilot subcarrier indices of one or more 160 MHz RUs to a left side of a center frequency of the 640 MHz bandwidth by a shift of −3072; (b) generating a second group of data and pilot subcarrier indices of one or more 160 MHz RUs to the left side of the center frequency by a shift of −1024; (c) generating a third group of data and pilot subcarrier indices of one or more 160 MHz RUs to a right side of the center frequency by a shift of +1024; and (d) generating a fourth group of data and pilot subcarrier indices of one or more 160 MHz RUs to the right side of the center frequency by a shift of +3072.

In some implementations, the wide bandwidth may include a 640 MHz bandwidth. In such cases, in generating the one or more RUs, processor 1912 may perform certain operations, including: (a) generating a first group of data and pilot subcarrier indices of one or more 320 MHz RUs to a left side of a center frequency of the 640 MHz bandwidth by a shift of −2048; and (b) generating a third group of data and pilot subcarrier indices of one or more 320 MHz RUs to a right side of the center frequency by a shift of +2048.

In some implementations, the one or more RUs may include at least a 26-tone RU, a 52-tone RU, a 106-tone RU, a 242-tone RU, a 484-tone RU or a 996-tone RU. In such cases, in response to the wide bandwidth being a 240 MHz bandwidth, in generating the one or more RUs, processor 1912 may perform certain operations, including: (a) generating a first group of pilot subcarrier indices of one or more 80 MHz RUs to a left side of a center frequency of the 240 MHz bandwidth by a shift of −1024; and (b) generating a second group of pilot subcarrier indices of one or more 80 MHz RUs to a right side of the center frequency by a shift of +1024.

In some implementations, the one or more RUs may include at least a 26-tone RU, a 52-tone RU, a 106-tone RU, a 242-tone RU, a 484-tone RU or a 996-tone RU. In such cases, in response to the wide bandwidth being a 480 MHz bandwidth, in generating the one or more RUs, processor 1912 may perform a first option or a second option. The first option may involve: (a) generating a first group of pilot subcarrier indices of one or more 160 MHz RUs to a left side of a center frequency of the 480 MHz bandwidth by a shift of −2048; and (d) generating a second group of pilot subcarrier indices of one or more 160 MHz RUs to a right side of the center frequency by a shift of +2048. The second option may involve: (a) generating a first group of pilot subcarrier indices of one or more 240 MHz RUs to a left side of the center frequency of the 480 MHz bandwidth by a shift of −1536; and (b) generating a second group of pilot subcarrier indices of one or more 240 MHz RUs to a right side of the center frequency by a shift of +1536.

In some implementations, the one or more RUs may include at least a 26-tone RU, a 52-tone RU, a 106-tone RU, a 242-tone RU, a 484-tone RU or a 996-tone RU. In such cases, in response to the wide bandwidth being a 640 MHz bandwidth, in generating the one or more RUs, processor 1912 may perform certain operations, including: (a) generating a first group of pilot subcarrier indices of one or more 320 MHz RUs to a left side of a center frequency of the 640 MHz bandwidth by a shift of −2048; and (b) generating a second group of pilot subcarrier indices of one or more 320 MHz RUs to a right side of the center frequency by a shift of +2048.

In some implementations, the one or more RUs may include at least a 2×996-tone RU. In such cases, in response to the wide bandwidth being a 480 MHz bandwidth, in response to the wide bandwidth being a 640 MHz bandwidth, in generating the one or more RUs, processor 1912 may perform certain operations, including: (a) generating a first group of pilot subcarrier indices of one or more 160 MHz RUs to a left side of a center frequency of the 480 MHz bandwidth by a shift of −2048; and (b) generating a second group of pilot subcarrier indices of one or more 160 MHz RUs to a right side of the center frequency by a shift of +2048. Alternatively, in response to the wide bandwidth being a 640 MHz bandwidth, in generating the one or more RUs, processor 1912 may perform a first option or a second option. The first option may involve: (a) generating a first group of pilot subcarrier indices of one or more 160 MHz RUs to a left side of a center frequency of the 640 MHz bandwidth by a shift of −3072; (b) generating a second group of pilot subcarrier indices of one or more 160 MHz RUs to the left side of the center frequency by a shift of −1024; (c) generating a third group of pilot subcarrier indices of one or more 160 MHz RUs to a right side of the center frequency by a shift of +1024; and (d) generating a fourth group of pilot subcarrier indices of one or more 160 MHz RUs to the right side of the center frequency by a shift of +3072. The second option may involve: (a) generating a first group of pilot subcarrier indices of one or more 320 MHz RUs to a left side of a center frequency of the 640 MHz bandwidth by a shift of −2048; and (b) generating a second group of pilot subcarrier indices of one or more 160 MHz RUs to a right side of the center frequency by a shift of +2048.

In some implementations, the wide bandwidth may include a 640 MHz bandwidth, and the one or more RUs may include at least a 4×996-tone RU. In such cases, in generating the one or more RUs, processor 1912 may perform certain operations, including: (a) generating a first group of pilot subcarrier indices of one or more 320 MHz RUs to a left side of a center frequency of the 640 MHz bandwidth by a shift of −2048; and (b) generating a second group of pilot subcarrier indices of one or more 320 MHz RUs to a right side of the center frequency by a shift of +2048.

In some implementations, the wide bandwidth may include a 240 MHz bandwidth, and the one or more RUs may include at least a 3×996-tone RU. In such cases, the pilot subcarrier indices may include {−1492, −1424, −1358, −1290, −1244, −1176, −1110, −1042, −1006, −938, −872, −804, −758, −690, −624, −556, −468, −400, −334, −266, −220, −152, −86, −18, 18, 86, 152, 220, 266, 334, 400, 468, 556, 624, 690, 758, 804, 872, 938, 1006, 1042, 1110, 1176, 1244, 1290, 1358, 1424, 1492}.

In some implementations, the wide bandwidth may include a 480 MHz bandwidth, and the one or more RUs may include at least a 3×996-tone RU. In such cases, in generating the one or more RUs, processor 1912 may perform certain operations, including: (a) generating a first group of pilot subcarrier indices of one or more 240 MHz RUs to a left side of a center frequency of the 480 MHz bandwidth by a shift of −1536; and (b) generating a second group of pilot subcarrier indices of one or more 240 MHz RUs to a right side of the center frequency by a shift of +1536.

In some implementations, the wide bandwidth may include a 480 MHz bandwidth, and the one or more RUs may include at least a 6×996-tone RU. In such cases, the pilot subcarrier indices may include {−3028, −2960, −2894, −2826, −2780, −2712, −2646, −2578, −2542, −2474, −2408, −2340, −2294, −2226, −2160, −2092, −2004, −1936, −1870, −1802, −1756, −1688, −1622, −1554, −1518, −1450, −1384, −1316, −1270, −1202, −1136, −1068, −980, −912, −846, −778, −732, −664, −598, −530, −494, −426, −360, −292, −246, −178, −112, −44, 44, 112, 178, 246, 292, 360, 426, 494, 530, 598, 664, 732, 778, 846, 912, 980, 1068, 1136, 1202, 1270, 1316, 1384, 1450, 1518, 1554, 1622, 1688, 1756, 1802, 1870, 1936, 2004, 2092, 2160, 2226, 2294, 2340, 2408, 2474, 2542, 2578, 2646, 2712, 2780, 2826, 2894, 2960, 3028}.

In some implementations, the wide bandwidth may include a 640 MHz bandwidth, and the one or more RUs may include at least an 8×996-tone RU. In such cases, the pilot subcarrier indices may include {−4052, −3984, −3918, −3850, −3804, −3736, −3670, −3602, −3566, −3498, −3432, −3364, −3318, −3250, −3184, −3116, −3028, −2960, −2894, −2826, −2780, −2712, −2646, −2578, −2542, −2474, −2408, −2340, −2294, −2226, −2160, −2092, −2004, −1936, −1870, −1802, −1756, −1688, −1622, −1554, −1518, −1450, −1384, −1316, −1270, −1202, −1136, −1068, −980, −912, −846, −778, −732, −664, −598, −530, −494, −426, −360, −292, −246, −178, −112, −44, 44, 112, 178, 246, 292, 360, 426, 494, 530, 598, 664, 732, 778, 846, 912, 980, 1068, 1136, 1202, 1270, 1316, 1384, 1450, 1518, 1554, 1622, 1688, 1756, 1802, 1870, 1936, 2004, 2092, 2160, 2226, 2294, 2340, 2408, 2474, 2542, 2578, 2646, 2712, 2780, 2826, 2894, 2960, 3028, 3116, 3184, 3250, 3318, 3364, 3432, 3498, 3566, 3602, 3670, 3736, 3804, 3850, 3918, 3984, 4052}.

### Illustrative Processes

FIG. 20 illustrates an example process 2000 in accordance with an implementation of the present disclosure. Process 2000 may represent an aspect of implementing various proposed designs, concepts, schemes, systems and methods described above. More specifically, process 2000 may represent an aspect of the proposed concepts and schemes pertaining to designs of data and pilot subcarrier indices of wide bandwidth RUs for next-generation WLANs in accordance with the present disclosure. Process 2000 may include one or more operations, actions, or functions as illustrated by one or more of blocks 2010 and 2020. Although illustrated as discrete blocks, various blocks of process 2000 may be divided into additional blocks, combined into fewer blocks, or eliminated, depending on the desired implementation. Moreover, the blocks/sub-blocks of process 2000 may be executed in the order shown in FIG. 20 or, alternatively in a different order. Furthermore, one or more of the blocks/sub-blocks of process 2000 may be executed repeatedly or iteratively. Process 2000 may be implemented by or in apparatus 1910 and apparatus 1920 as well as any variations thereof. Solely for illustrative purposes and without limiting the scope, process 2000 is described below in the context of apparatus 1910 implemented in or as STA 110 functioning as a non-AP STA and apparatus 1920 implemented in or as STA 120 functioning as an AP STA of a wireless network such as a WLAN in network environment 100 in accordance with one or more of IEEE 802.11 standards. Process 2000 may begin at block 2010.

At 2010, process 2000 may involve processor 1912 of apparatus 1910 generating one or more RUs with a SCS of 78.125 kHz and with a constant shift applied to at least a portion of data and pilot subcarrier indices of the one or more RUs. Process 2000 may proceed from 2010 to 2020.

At 2020, process 2000 may involve processor 1912 wirelessly transmitting, via transceiver 1916, the one or more RUs in a wide bandwidth greater than 80 MHz (e.g., transmitting to and/or receiving from apparatus 1920).

In some implementations, in transmitting the one or more RUs, process 2000 may involve processor 1912 transmitting the one or more RUs in a 240 MHz, 480 MHz or 640 MHz bandwidth.

In some implementations, the wide bandwidth may include a 240 MHz bandwidth. In such cases, in generating the one or more RUs, process 2000 may involve processor 1912 performing certain operations, including: (a) generating a first group of data and pilot subcarrier indices of one or more 80 MHz RUs around a center frequency of the 240 MHz bandwidth; (b) generating a second group of data and pilot subcarrier indices of one or more 80 MHz RUs to a left side of the center frequency by a shift of −1024; and (c) generating a third group of data and pilot subcarrier indices of one or more 80 MHz RUs to a right side of the center frequency by a shift of +1024.

In some implementations, the wide bandwidth may include a 480 MHz bandwidth. In such cases, in generating the one or more RUs, process 2000 may involve processor 1912 performing certain operations, including: (a) generating a first group of data and pilot subcarrier indices of one or more 80 MHz RUs to a left side of a center frequency of the 480 MHz bandwidth by a shift of −2560; (b) generating a second group of data and pilot subcarrier indices of one or more 80 MHz RUs to the left side of the center frequency by a shift of −1536; (c) generating a third group of data and pilot subcarrier indices of one or more 80 MHz RUs to the left side of the center frequency by a shift of −512; (d) generating a fourth group of data and pilot subcarrier indices of one or more 80 MHz RUs to a right side of the center frequency by a shift of +512; (e) generating a fifth group of data and pilot subcarrier indices of one or more 80 MHz RUs to the right side of the center frequency by a shift of +1536; and (f) generating a sixth group of data and pilot subcarrier indices of one or more 80 MHz RUs to the right side of the center frequency by a shift of +2560.

In some implementations, the wide bandwidth may include a 480 MHz bandwidth. In such cases, in generating the one or more RUs, process 2000 may involve processor 1912 performing certain operations, including: (a) generating a first group of data and pilot subcarrier indices of one or more 160 MHz RUs around a center frequency of the 480 MHz bandwidth; (b) generating a second group of data and pilot subcarrier indices of one or more 160 MHz RUs to a left side of the center frequency by a shift of −2048; and (c) generating a third group of data and pilot subcarrier indices of one or more 160 MHz RUs to a right side of the center frequency by a shift of +2048.

In some implementations, the wide bandwidth may include a 480 MHz bandwidth. In such cases, in generating the one or more RUs, process 2000 may involve processor 1912 performing certain operations, including: (a) generating a first group of data and pilot subcarrier indices of one or more 240 MHz RUs to a left side of a center frequency of the 480 MHz bandwidth by a shift of −1536; and (b) generating a second group of data and pilot subcarrier indices of one or more 240 MHz RUs to a right side of the center frequency by a shift of +1536.

In some implementations, the wide bandwidth may include a 640 MHz bandwidth. In such cases, in generating the one or more RUs, process 2000 may involve processor 1912 performing certain operations, including: (a) generating a first group of data and pilot subcarrier indices of one or more 80 MHz RUs to a left side of a center frequency of the 640 MHz bandwidth by a shift of −3584; (b) generating a second group of data and pilot subcarrier indices of one or more 80 MHz RUs to the left side of the center frequency by a shift of −2560; (c) generating a third group of data and pilot subcarrier indices of one or more 80 MHz RUs to the left side of the center frequency by a shift of −1536; (d) generating a fourth group of data and pilot subcarrier indices of one or more 80 MHz RUs to the left side of the center frequency by a shift of −512; (e) generating a fifth group of data and pilot subcarrier indices of one or more 80 MHz RUs to a right side of the center frequency by a shift of +512; (f) generating a sixth group of data and pilot subcarrier indices of one or more 80 MHz RUs to the right side of the center frequency by a shift of +1536; (g) generating a seventh group of data and pilot subcarrier indices of one or more 80 MHz RUs to the right side of the center frequency by a shift of +2560; and (h) generating an eighth group of data and pilot subcarrier indices of one or more 80 MHz RUs to the right side of the center frequency by a shift of +3584.

In some implementations, the wide bandwidth may include a 640 MHz bandwidth. In such cases, in generating the one or more RUs, process 2000 may involve processor 1912 performing certain operations, including: (a) generating a first group of data and pilot subcarrier indices of one or more 160 MHz RUs to a left side of a center frequency of the 640 MHz bandwidth by a shift of −3072; (b) generating a second group of data and pilot subcarrier indices of one or more 160 MHz RUs to the left side of the center frequency by a shift of −1024; (c) generating a third group of data and pilot subcarrier indices of one or more 160 MHz RUs to a right side of the center frequency by a shift of +1024; and (d) generating a fourth group of data and pilot subcarrier indices of one or more 160 MHz RUs to the right side of the center frequency by a shift of +3072.

In some implementations, the wide bandwidth may include a 640 MHz bandwidth. In such cases, in generating the one or more RUs, process 2000 may involve processor 1912 performing certain operations, including: (a) generating a first group of data and pilot subcarrier indices of one or more 320 MHz RUs to a left side of a center frequency of the 640 MHz bandwidth by a shift of −2048; and (b) generating a third group of data and pilot subcarrier indices of one or more 320 MHz RUs to a right side of the center frequency by a shift of +2048.

In some implementations, the one or more RUs may include at least a 26-tone RU, a 52-tone RU, a 106-tone RU, a 242-tone RU, a 484-tone RU or a 996-tone RU. In such cases, in response to the wide bandwidth being a 240 MHz bandwidth, in generating the one or more RUs, process 2000 may involve processor 1912 performing certain operations, including: (a) generating a first group of pilot subcarrier indices of one or more 80 MHz RUs to a left side of a center frequency of the 240 MHz bandwidth by a shift of −1024; and (b) generating a second group of pilot subcarrier indices of one or more 80 MHz RUs to a right side of the center frequency by a shift of +1024.

In some implementations, the one or more RUs may include at least a 26-tone RU, a 52-tone RU, a 106-tone RU, a 242-tone RU, a 484-tone RU or a 996-tone RU. In such cases, in response to the wide bandwidth being a 480 MHz bandwidth, in generating the one or more RUs, process 2000 may involve processor 1912 performing a first option or a second option. The first option may involve: (a) generating a first group of pilot subcarrier indices of one or more 160 MHz RUs to a left side of a center frequency of the 480 MHz bandwidth by a shift of −2048; and (d) generating a second group of pilot subcarrier indices of one or more 160 MHz RUs to a right side of the center frequency by a shift of +2048. The second option may involve: (a) generating a first group of pilot subcarrier indices of one or more 240 MHz RUs to a left side of the center frequency of the 480 MHz bandwidth by a shift of −1536; and (b) generating a second group of pilot subcarrier indices of one or more 240 MHz RUs to a right side of the center frequency by a shift of +1536.

In some implementations, the one or more RUs may include at least a 26-tone RU, a 52-tone RU, a 106-tone RU, a 242-tone RU, a 484-tone RU or a 996-tone RU. In such cases, in response to the wide bandwidth being a 640 MHz bandwidth, in generating the one or more RUs, process 2000 may involve processor 1912 performing certain operations, including: (a) generating a first group of pilot subcarrier indices of one or more 320 MHz RUs to a left side of a center frequency of the 640 MHz bandwidth by a shift of −2048; and (b) generating a second group of pilot subcarrier indices of one or more 320 MHz RUs to a right side of the center frequency by a shift of +2048.

In some implementations, the one or more RUs may include at least a 2×996-tone RU. In such cases, in response to the wide bandwidth being a 480 MHz bandwidth, in response to the wide bandwidth being a 640 MHz bandwidth, in generating the one or more RUs, process 2000 may involve processor 1912 performing certain operations, including: (a) generating a first group of pilot subcarrier indices of one or more 160 MHz RUs to a left side of a center frequency of the 480 MHz bandwidth by a shift of −2048; and (b) generating a second group of pilot subcarrier indices of one or more 160 MHz RUs to a right side of the center frequency by a shift of +2048. Alternatively, in response to the wide bandwidth being a 640 MHz bandwidth, in generating the one or more RUs, process 2000 may involve processor 1912 performing a first option or a second option. The first option may involve: (a) generating a first group of pilot subcarrier indices of one or more 160 MHz RUs to a left side of a center frequency of the 640 MHz bandwidth by a shift of −3072; (b) generating a second group of pilot subcarrier indices of one or more 160 MHz RUs to the left side of the center frequency by a shift of −1024; (c) generating a third group of pilot subcarrier indices of one or more 160 MHz RUs to a right side of the center frequency by a shift of +1024; and (d) generating a fourth group of pilot subcarrier indices of one or more 160 MHz RUs to the right side of the center frequency by a shift of +3072. The second option may involve: (a) generating a first group of pilot subcarrier indices of one or more 320 MHz RUs to a left side of a center frequency of the 640 MHz bandwidth by a shift of −2048; and (b) generating a second group of pilot subcarrier indices of one or more 160 MHz RUs to a right side of the center frequency by a shift of +2048.

In some implementations, the wide bandwidth may include a 640 MHz bandwidth, and the one or more RUs may include at least a 4×996-tone RU. In such cases, in generating the one or more RUs, process 2000 may involve processor 1912 performing certain operations, including: (a) generating a first group of pilot subcarrier indices of one or more 320 MHz RUs to a left side of a center frequency of the 640 MHz bandwidth by a shift of −2048; and (b) generating a second group of pilot subcarrier indices of one or more 320 MHz RUs to a right side of the center frequency by a shift of +2048.

In some implementations, the wide bandwidth may include a 240 MHz bandwidth, and the one or more RUs may include at least a 3×996-tone RU. In such cases, the pilot subcarrier indices may include {−1492, −1424, −1358, −1290, −1244, −1176, −1110, −1042, −1006, −938, −-872, −804, -758, −690, −624, −556, −468, −400, −334, −266, −220, −152, −86, −18, 18, 86, 152, 220, 266, 334, 400, 468, 556, 624, 690, 758, 804, 872, 938, 1006, 1042, 1110, 1176, 1244, 1290, 1358, 1424, 1492}.

In some implementations, the wide bandwidth may include a 480 MHz bandwidth, and the one or more RUs may include at least a 3×996-tone RU. In such cases, in generating the one or more RUs, process 2000 may involve processor 1912 performing certain operations, including: (a) generating a first group of pilot subcarrier indices of one or more 240 MHz RUs to a left side of a center frequency of the 480 MHz bandwidth by a shift of −1536; and (b) generating a second group of pilot subcarrier indices of one or more 240 MHz RUs to a right side of the center frequency by a shift of +1536.

In some implementations, the wide bandwidth may include a 480 MHz bandwidth, and the one or more RUs may include at least a 6×996-tone RU. In such cases, the pilot subcarrier indices may include {−3028, −2960, −2894, −2826, −2780, −2712, −2646, −2578, −2542, −2474, −2408, −2340, −2294, −2226, −2160, −2092, −2004, −1936, −1870, −1802, −1756, −1688, −1622, −1554, −1518, −1450, −1384, −1316, −1270, −1202, −1136, −1068, −980, −912, −846, −778, −732, −664, −598, −530, −494, −426, −360, −292, −246, −178, −112, −44, 44, 112, 178, 246, 292, 360, 426, 494, 530, 598, 664, 732, 778, 846, 912, 980, 1068, 1136, 1202, 1270, 1316, 1384, 1450, 1518, 1554, 1622, 1688, 1756, 1802, 1870, 1936, 2004, 2092, 2160, 2226, 2294, 2340, 2408, 2474, 2542, 2578, 2646, 2712, 2780, 2826, 2894, 2960, 3028}.

In some implementations, the wide bandwidth may include a 640 MHz bandwidth, and the one or more RUs may include at least an 8×996-tone RU. In such cases, the pilot subcarrier indices may include {−4052, −3984, −3918, −3850, −3804, −3736, −3670, −3602, −3566, −3498, −3432, −3364, −3318, −3250, −3184, −3116, −3028, −2960, −2894, −2826, −2780, −2712, −2646, −2578, −2542, −2474, −2408, −2340, −2294, −2226, −2160, −2092, −2004, −1936, −1870, −1802, −1756, −1688, −1622, −1554, −1518, −1450, −1384, −1316, −1270, −1202, −1136, −1068, −980, −912, −846, −778, −732, −664, −598, −530, −494, −426, −360, −292, −246, −178, −112, −44, 44, 112, 178, 246, 292, 360, 426, 494, 530, 598, 664, 732, 778, 846, 912, 980, 1068, 1136, 1202, 1270, 1316, 1384, 1450, 1518, 1554, 1622, 1688, 1756, 1802, 1870, 1936, 2004, 2092, 2160, 2226, 2294, 2340, 2408, 2474, 2542, 2578, 2646, 2712, 2780, 2826, 2894, 2960, 3028, 3116, 3184, 3250, 3318, 3364, 3432, 3498, 3566, 3602, 3670, 3736, 3804, 3850, 3918, 3984, 4052}.

### Additional Notes

The herein-described subject matter sometimes illustrates different components contained within, or connected with, different other components. It is to be understood that such depicted architectures are merely examples, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

Further, with respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

Moreover, it will be understood by those skilled in the art that, in general, terms used herein, and especially in the appended claims, e.g., bodies of the appended claims, are generally intended as “open” terms, e.g., the term “including” should be interpreted as “including but not limited to,” the term “having” should be interpreted as “having at least,” the term “includes” should be interpreted as “includes but is not limited to,” etc. It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to implementations containing only one such recitation, even when the same claim includes the introductory phrases “one or more” or “at least one” and indefinite articles such as “a” or “an,” e.g., “a” and/or “an” should be interpreted to mean “at least one” or “one or more;” the same holds true for the use of definite articles used to introduce claim recitations. In addition, even if a specific number of an introduced claim recitation is explicitly recited, those skilled in the art will recognize that such recitation should be interpreted to mean at least the recited number, e.g., the bare recitation of “two recitations,” without other modifiers, means at least two recitations, or two or more recitations. Furthermore, in those instances where a convention analogous to “at least one of A, B, and C, etc.” is used, in general such a construction is intended in the sense one having skill in the art would understand the convention, e.g., “a system having at least one of A, B, and C” would include but not be limited to systems that have A alone, B alone, C alone, A and B together, A and C together, B and C together, and/or A, B, and C together, etc. In those instances where a convention analogous to “at least one of A, B, or C, etc.” is used, in general such a construction is intended in the sense one having skill in the art would understand the convention, e.g., “a system having at least one of A, B, or C” would include but not be limited to systems that have A alone, B alone, C alone, A and B together, A and C together, B and C together, and/or A, B, and C together, etc. It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

From the foregoing, it will be appreciated that various implementations of the present disclosure have been described herein for purposes of illustration, and that various modifications may be made without departing from the scope and spirit of the present disclosure. Accordingly, the various implementations disclosed herein are not intended to be limiting, with the true scope and spirit being indicated by the following claims.

What is claimed is:

1. A method, comprising:
generating one or more resource units (RUs) with a subcarrier spacing (SCS) of 78.125 kHz and with a constant shift applied to at least a portion of data and pilot subcarrier indices of the one or more RUs; and
wirelessly transmitting the one or more RUs in a wide bandwidth greater than 80 MHz.

2. The method of claim 1, wherein the transmitting of the one or more RUs comprises transmitting the one or more RUs in a 240 MHz, 480 MHz or 640 MHz bandwidth.

3. The method of claim 1, wherein the wide bandwidth comprises a 240 MHz bandwidth, and wherein the generating of the one or more RUs comprises:
generating a first group of data and pilot subcarrier indices of one or more 80 MHz RUs around a center frequency of the 240 MHz bandwidth;
generating a second group of data and pilot subcarrier indices of one or more 80 MHz RUs to a left side of the center frequency by a shift of −1024; and
generating a third group of data and pilot subcarrier indices of one or more 80 MHz RUs to a right side of the center frequency by a shift of +1024.

4. The method of claim 1, wherein the wide bandwidth comprises a 480 MHz bandwidth, and wherein the generating of the one or more RUs comprises:
generating a first group of data and pilot subcarrier indices of one or more 80 MHz RUs to a left side of a center frequency of the 480 MHz bandwidth by a shift of −2560;
generating a second group of data and pilot subcarrier indices of one or more 80 MHz RUs to the left side of the center frequency by a shift of −1536;
generating a third group of data and pilot subcarrier indices of one or more 80 MHz RUs to the left side of the center frequency by a shift of −512;
generating a fourth group of data and pilot subcarrier indices of one or more 80 MHz RUs to a right side of the center frequency by a shift of +512;
generating a fifth group of data and pilot subcarrier indices of one or more 80 MHz RUs to the right side of the center frequency by a shift of +1536; and
generating a sixth group of data and pilot subcarrier indices of one or more 80 MHz RUs to the right side of the center frequency by a shift of +2560.

5. The method of claim 1, wherein the wide bandwidth comprises a 480 MHz bandwidth, and wherein the generating of the one or more RUs comprises:
generating a first group of data and pilot subcarrier indices of one or more 160 MHz RUs around a center frequency of the 480 MHz bandwidth;
generating a second group of data and pilot subcarrier indices of one or more 160 MHz RUs to a left side of the center frequency by a shift of −2048; and
generating a third group of data and pilot subcarrier indices of one or more 160 MHz RUs to a right side of the center frequency by a shift of +2048.

6. The method of claim 1, wherein the wide bandwidth comprises a 480 MHz bandwidth, and wherein the generating of the one or more RUs comprises:
generating a first group of data and pilot subcarrier indices of one or more 240 MHz RUs to a left side of a center frequency of the 480 MHz bandwidth by a shift of −1536; and
generating a second group of data and pilot subcarrier indices of one or more 240 MHz RUs to a right side of the center frequency by a shift of +1536.

7. The method of claim 1, wherein the wide bandwidth comprises a 640 MHz bandwidth, and wherein the generating of the one or more RUs comprises:
generating a first group of data and pilot subcarrier indices of one or more 80 MHz RUs to a left side of a center frequency of the 640 MHz bandwidth by a shift of −3584;
generating a second group of data and pilot subcarrier indices of one or more 80 MHz RUs to the left side of the center frequency by a shift of −2560;
generating a third group of data and pilot subcarrier indices of one or more 80 MHz RUs to the left side of the center frequency by a shift of −1536;
generating a fourth group of data and pilot subcarrier indices of one or more 80 MHz RUs to the left side of the center frequency by a shift of −512;
generating a fifth group of data and pilot subcarrier indices of one or more 80 MHz RUs to a right side of the center frequency by a shift of +512;
generating a sixth group of data and pilot subcarrier indices of one or more 80 MHz RUs to the right side of the center frequency by a shift of +1536;
generating a seventh group of data and pilot subcarrier indices of one or more 80 MHz RUs to the right side of the center frequency by a shift of +2560; and
generating an eighth group of data and pilot subcarrier indices of one or more 80 MHz RUs to the right side of the center frequency by a shift of +3584.

8. The method of claim 1, wherein the wide bandwidth comprises a 640 MHz bandwidth, and wherein the generating of the one or more RUs comprises:
generating a first group of data and pilot subcarrier indices of one or more 160 MHz RUs to a left side of a center frequency of the 640 MHz bandwidth by a shift of −3072;
generating a second group of data and pilot subcarrier indices of one or more 160 MHz RUs to the left side of the center frequency by a shift of −1024;
generating a third group of data and pilot subcarrier indices of one or more 160 MHz RUs to a right side of the center frequency by a shift of +1024; and
generating a fourth group of data and pilot subcarrier indices of one or more 160 MHz RUs to the right side of the center frequency by a shift of +3072.

9. The method of claim 1, wherein the wide bandwidth comprises a 640 MHz bandwidth, and wherein the generating of the one or more RUs comprises:
generating a first group of data and pilot subcarrier indices of one or more 320 MHz RUs to a left side of a center frequency of the 640 MHz bandwidth by a shift of −2048; and
generating a third group of data and pilot subcarrier indices of one or more 320 MHz RUs to a right side of the center frequency by a shift of +2048.

10. The method of claim 1, wherein the one or more RUs comprise at least a 26-tone RU, a 52-tone RU, a 106-tone RU, a 242-tone RU, a 484-tone RU or a 996-tone RU, and wherein, responsive to the wide bandwidth being a 240 MHz bandwidth, the generating of the one or more RUs comprises:
generating a first group of pilot subcarrier indices of one or more 80 MHz RUs to a left side of a center frequency of the 240 MHz bandwidth by a shift of −1024; and
generating a second group of pilot subcarrier indices of one or more 80 MHz RUs to a right side of the center frequency by a shift of +1024.

11. The method of claim 1, wherein the one or more RUs comprise at least a 26-tone RU, a 52-tone RU, a 106-tone RU, a 242-tone RU, a 484-tone RU or a 996-tone RU, wherein, responsive to the wide bandwidth being a 480 MHz bandwidth, the generating of the one or more RUs comprises performing a first option or a second option, and wherein:
the first option comprises:
generating a first group of pilot subcarrier indices of one or more 160 MHz RUs to a left side of a center frequency of the 480 MHz bandwidth by a shift of −2048; and
generating a second group of pilot subcarrier indices of one or more 160 MHz RUs to a right side of the center frequency by a shift of +2048, and
the second option comprises:
generating a first group of pilot subcarrier indices of one or more 240 MHz RUs to a left side of the center frequency of the 480 MHz bandwidth by a shift of −1536; and
generating a second group of pilot subcarrier indices of one or more 240 MHz RUs to a right side of the center frequency by a shift of +1536.

12. The method of claim 1, wherein the one or more RUs comprise at least a 26-tone RU, a 52-tone RU, a 106-tone RU, a 242-tone RU, a 484-tone RU or a 996-tone RU, and wherein, responsive to the wide bandwidth being a 640 MHz bandwidth, the generating of the one or more RUs comprises:
generating a first group of pilot subcarrier indices of one or more 320 MHz RUs to a left side of a center frequency of the 640 MHz bandwidth by a shift of −2048; and
generating a second group of pilot subcarrier indices of one or more 320 MHz RUs to a right side of the center frequency by a shift of +2048.

13. The method of claim 1, wherein the one or more RUs comprise at least a 2×996-tone RU, and wherein:
responsive to the wide bandwidth being a 480 MHz bandwidth, the generating of the one or more RUs comprises:
generating a first group of pilot subcarrier indices of one or more 160 MHz RUs to a left side of a center frequency of the 480 MHz bandwidth by a shift of −2048; and
generating a second group of pilot subcarrier indices of one or more 160 MHz RUs to a right side of the center frequency by a shift of +2048,
responsive to the wide bandwidth being a 640 MHz bandwidth, the generating of the one or more RUs comprises performing a first option or a second option,
the first option comprises:
generating a first group of pilot subcarrier indices of one or more 160 MHz RUs to a left side of a center frequency of the 640 MHz bandwidth by a shift of −3072;
generating a second group of pilot subcarrier indices of one or more 160 MHz RUs to the left side of the center frequency by a shift of −1024;
generating a third group of pilot subcarrier indices of one or more 160 MHz RUs to a right side of the center frequency by a shift of +1024; and
generating a fourth group of pilot subcarrier indices of one or more 160 MHz RUs to the right side of the center frequency by a shift of +3072, and
the second option comprises:
generating a first group of pilot subcarrier indices of one or more 320 MHz RUs to a left side of a center frequency of the 640 MHz bandwidth by a shift of −2048; and
generating a second group of pilot subcarrier indices of one or more 160 MHz RUs to a right side of the center frequency by a shift of +2048.

14. The method of claim 1, wherein the wide bandwidth comprises a 640 MHz bandwidth, wherein the one or more RUs comprise at least a 4×996-tone RU, and wherein the generating of the one or more RUs comprises:
generating a first group of pilot subcarrier indices of one or more 320 MHz RUs to a left side of a center frequency of the 640 MHz bandwidth by a shift of −2048; and
generating a second group of pilot subcarrier indices of one or more 320 MHz RUs to a right side of the center frequency by a shift of +2048.

15. The method of claim 1, wherein the one or more RUs comprise at least a 3×996-tone RU, wherein the wide bandwidth comprises a 240 MHz bandwidth, and wherein the pilot subcarrier indices comprise {−1492, −1424, −1358, −1290, −1244, −1176, −1110, −1042, −1006, −938, −872, −804, −758, −690, −624, −556, −468, −400, −334, −266, −220, −152, −86, −18, 18, 86, 152, 220, 266, 334, 400, 468, 556, 624, 690, 758, 804, 872, 938, 1006, 1042, 1110, 1176, 1244, 1290, 1358, 1424, 1492}.

16. The method of claim 1, wherein the one or more RUs comprise at least a 3×996-tone RU, wherein the wide bandwidth comprises a 480 MHz bandwidth, and wherein the generating of the one or more RUs comprises:
generating a first group of pilot subcarrier indices of one or more 240 MHz RUs to a left side of a center frequency of the 480 MHz bandwidth by a shift of −1536; and
generating a second group of pilot subcarrier indices of one or more 240 MHz RUs to a right side of the center frequency by a shift of +1536.

17. The method of claim 1, wherein the wide bandwidth comprises a 480 MHz bandwidth, wherein the one or more RUs comprise at least a 6×996-tone RU, and wherein the pilot subcarrier indices comprise {−3028, −2960, −2894, −2826, −2780, −2712, −2646, −2578, −2542, −2474, −2408, −2340, −2294, −2226, −2160, −2092, −2004, −1936, −1870, −1802, −1756, −1688, −1622, −1554, −1518, −1450, −1384, −1316, −1270, −1202, −1136, −1068, −980, −912, −846, −778, −732, −664, −598, −530, −494, −426, −360, −292, −246, −178, −112, −44, 44, 112, 178, 246, 292, 360, 426, 494, 530, 598, 664, 732, 778, 846, 912, 980, 1068, 1136, 1202, 1270, 1316, 1384, 1450, 1518, 1554, 1622, 1688, 1756, 1802, 1870, 1936, 2004, 2092, 2160, 2226, 2294, 2340, 2408, 2474, 2542, 2578, 2646, 2712, 2780, 2826, 2894, 2960, 3028}.

18. The method of claim 1, wherein the wide bandwidth comprises a 640 MHz bandwidth, wherein the one or more RUs comprise at least a 8×996-tone RU, and wherein the pilot subcarrier indices comprise {−4052, −3984, −3918, −3850, −3804, −3736, −3670, −3602, −3566, −3498, −3432, −3364, −3318, −3250, −3184, −3116, −3028, −2960, −2894, −2826, −2780, −2712, −2646, −2578, −2542, −2474, −2408, −2340, −2294, −2226, −2160, −2092, −2004, −1936, −1870, −1802, −1756, −1688, −1622, −1554, −1518, −1450, −1384, −1316, −1270, −1202, −1136, −1068, −980, −912, −846, −778, −732, −664, −598, −530, −494, −426, −360, −292, −246, −178, −112, −44, 44, 112, 178, 246, 292, 360, 426, 494, 530, 598, 664, 732, 778, 846, 912, 980, 1068, 1136, 1202, 1270, 1316, 1384, 1450, 1518, 1554, 1622, 1688, 1756, 1802, 1870, 1936, 2004, 2092, 2160, 2226, 2294, 2340, 2408, 2474, 2542, 2578, 2646, 2712, 2780, 2826, 2894, 2960, 3028, 3116, 3184, 3250, 3318, 3364, 3432, 3498, 3566, 3602, 3670, 3736, 3804, 3850, 3918, 3984, 4052}.

19. An apparatus, comprising:
a transceiver configured to communicate wirelessly; and
a processor coupled to the transceiver and configured to perform operations comprising:
generating one or more resource units (RUs) with a subcarrier spacing (SCS) of 78.125 kHz and with a constant shift applied to at least a portion of data and pilot subcarrier indices of the one or more RUs; and
transmitting, via the transceiver, the one or more RUs in a wide bandwidth greater than 80 MHz.

20. The apparatus of claim 19, wherein the transmitting of the one or more RUs comprises transmitting the one or more RUs in a 240 MHz, 480 MHz or 640 MHz bandwidth.
